(19) United States
(12) Patent Application Publication
(10) Pub. No.: US 2026/0367476 A1
(43) Pub. Date: Nov. 19, 2026

(54) PIPELINED ENTANGLEMENT DISTRIBUTION ARCHITECTURE FOR QUANTUM CHARGE-COUPLED DEVICE (QCCD)-BASED QUANTUM COMPUTING

(71) Applicant: Quantinuum LLC, Broomfield, CO (US)

(72) Inventors: Christopher E. LANGER, Highlands Ranch, CO (US); Curtis VOLIN, Marietta, GA (US); Matthew BLAIN, Broomfield, CO (US)

(21) Appl. No.: 18/653,123

(22) Filed: May 2, 2024

Related U.S. Application Data
(60) Provisional application No. 63/500,710, filed on May 8, 2023.

(51) Int. Cl. G02F 3/00; G06N 10/20

(52) U.S. Cl. CPC G02F 3/00; G06N 10/20

(57) ABSTRACT

A multi-domain confinement apparatus is provided. The multi-domain confinement apparatus is configured for the pipelined distribution of entangled sets of e-bits for use in performing remote quantum logic operations. The multi-domain confinement apparatus includes an entanglement domain comprising an entanglement domain confinement device, a routing domain comprising one or more respective routing domain confinement devices, an interaction domain comprising an interaction domain confinement device. The entanglement domain defines one or more entanglement locations and the entanglement domain is configured for sets of e-bits to be entangled at respective entanglement locations. Each of the respective routing domain confinement devices and the interaction domain confinement device are configured to enable quantum objects to pass there through at respective inter-layer routing locations. The interaction domain defines a plurality of interaction locations and the interaction domain is configured for data qubit-e-bit pairs to be interacted at respective interaction locations.

### CROSS-RELATED APPLICATIONS

This application claims priority to U.S. Application No. 63/500,710, field May 8, 2023, the content of which is incorporated herein by reference in its entirety.

### TECHNICAL FIELD

Embodiments described herein generally relate to a pipelined entanglement distribution architecture for quantum charge-coupled device (QCCD)-based quantum computing. For example, various embodiments relate to the performance of remote quantum logic gates using entangled pairs of quantum objects. For example, various embodiments relate to methods, apparatus, systems, and computer program products for using pipelined distribution of entangled pairs of quantum objects for the performance of quantum computations.

### BACKGROUND

QCCD-based quantum computers used confined quantum objects (e.g., ions and/or the like) as data qubits of the quantum computer. The quantum objects may be transported to different locations within the confinement apparatus that confines the quantum objects to enable the pairing of arbitrary pairs of quantum objects for interaction. For example, arbitrary pairs of quantum objects may be generated such that quantum logic operations may be performed on the arbitrary pairs of quantum objects. However, the transportation operations used to transport the quantum objects within the confinement apparatus amount for a significant amount of time required by a QCCD-based quantum computer for performing quantum computations. Through applied effort, ingenuity, and innovation many deficiencies of such systems have been solved by developing solutions that are structured in accordance with the embodiments of the present invention, many examples of which are described in detail herein.

### BRIEF SUMMARY OF EXAMPLE EMBODIMENTS

Example embodiments provide methods, confinement apparatuses, controllers, systems, computer program products, and/or the like for performing remote quantum logic operations using pairs of entangled quantum objects. Example embodiments provide methods, confinement apparatuses, controllers, systems, computer program products, and/or the like for a pipelined distribution of entangled pairs of quantum objects for the performance of quantum computations.

According to a first aspect, a method for performing a remote two or more data qubit quantum logic operation is provided. The method is performed by a controller configured to control operation of one or more components of a quantum computer. In an example embodiment, the method comprises causing a set of e-bits to be entangled at an entangling location defined at least in part by a confinement apparatus, the set of e-bits comprising a first e-bit and a second e-bit; causing (a) routing of the first e-bit to a first interaction location defined at least in part by the confinement apparatus and (b) routing the second e-bit to a second interaction location defined at least in part by the confinement apparatus, wherein a first data qubit is disposed at the first interaction location and a second data qubit is disposed at the second interaction location; causing (a) interaction of the first e-bit and the first data qubit at the first interaction location and (b) interaction of the second e-bit and the second data qubit at the second interaction location; and causing (a) a first reading operation to be performed on one of the first data qubit or the first e-bit and (b) a second reading operation to be performed on one of the second data qubit or the second e-bit.

In an example embodiment, the method further comprises tracking one or more correction gates in a classical memory of the controller.

In an example embodiment, the set of e-bits are entangled at time step i of a quantum circuit being performed by the quantum computer, the interaction of the first e-bit with the first data qubit and the interaction of the second e-bit with the second data qubit occurs at a time step i + j of the quantum circuit, where i and j are positive integers.

In an example embodiment, the routing of the first e-bit to the first interaction location and the routing of the second e-bit to the second interaction location occurs between time step i and time step i + j of the quantum circuit.

In an example embodiment, the first e-bit is transported along a determined route from the entanglement location to the first interaction location in j route steps with each route step of the j route steps performed during a respective time step of the quantum circuit.

In an example embodiment, the method further comprises determining the determined route using a route-finding algorithm.

In an example embodiment, the confinement apparatus is a multi-domain confinement apparatus, the entanglement location is disposed in an entanglement domain of the multi-domain confinement apparatus, the first and second interaction locations are disposed in one or more interaction domains of the multi-domain confinement apparatus, and the first e-bit is routed to the first interaction location through a routing domain of the multi-domain confinement apparatus.

In an example embodiment, the multi-domain confinement apparatus is a multi-layer confinement apparatus comprising a plurality of layers with each domain of the multi-domain confinement apparatus comprises at least one respective layer of the plurality of layers.

In an example embodiment, wherein the first e-bit is embodied by a first quantum object, the second e-bit is embodied by a second quantum object, the first data qubit is embodied by a third quantum object, and the second data qubit is embodied by a fourth quantum object; wherein the first reading operation is performed on the third quantum object and the second reading operation is performed on the fourth quantum object; and the method further comprises causing the third quantum object to be transported out of the first interaction location; causing the first quantum object to assume the role of the first data qubit; causing the fourth quantum object to be transported out of the second interaction location; and causing the second quantum object to assume the role of the second data qubit.

In an example embodiment, the method further comprises causing the third quantum object and the fourth quantum object to be transported to respective entanglement locations of one or more entanglement locations of the confinement apparatus.

In an example embodiment, the first e-bit is embodied by a first quantum object, the second e-bit is embodied by a second quantum object, the first data qubit is embodied by a third quantum object, and the second data qubit is embodied by a fourth quantum object; wherein the first reading operation is performed on the first quantum object and the second reading operation is performed on the second quantum object; and the method further comprises causing the first quantum object to be transported out of the first interaction location; and causing the second quantum object to be transported out of the second interaction location.

In an example embodiment, the method further comprises causing the first quantum object and the second quantum object to be transported to respective entanglement locations of one or more entanglement locations of the confinement apparatus.

According to another aspect, a controller configured to control operation of one or more components of a quantum computer is provided. In an example embodiment, the controller comprises a memory storing executable instructions and at least one processing element. The controller is configured to execute the executable instructions via the at least one processing element to cause the controller to perform causing a set of e-bits to be entangled at an entangling location defined at least in part by a confinement apparatus, the set of e-bits comprising a first e-bit and a second e-bit; causing (a) routing of the first e-bit to a first interaction location defined at least in part by the confinement apparatus and (b) routing the second e-bit to a second interaction location defined at least in part by the confinement apparatus, wherein a first data qubit is disposed at the first interaction location and a second data qubit is disposed at the second interaction location; causing (a) interaction of the first e-bit and the first data qubit at the first interaction location and (b) interaction of the second e-bit and the second data qubit at the second interaction location; and causing (a) a first reading operation to be performed on one of the first data qubit or the first e-bit and (b) a second reading operation to be performed on one of the second data qubit or the second e-bit.

In an example embodiment, the controller is configured to execute the executable instructions via the at least one processing element to further cause the controller to perform tracking one or more correction gates in a classical memory of the controller.

In an example embodiment, the set of e-bits are entangled at time step i of a quantum circuit being performed by the quantum computer, the interaction of the first e-bit with the first data qubit and the interaction of the second e-bit with the second data qubit occurs at a time step i + j of the quantum circuit, where i and j are positive integers.

In an example embodiment, the routing of the first e-bit to the first interaction location and the routing of the second e-bit to the second interaction location occurs between time step i and time step i + j of the quantum circuit.

In an example embodiment, the first e-bit is transported along a determined route from the entanglement location to the first interaction location in j route steps with each route step of the j route steps performed during a respective time step of the quantum circuit.

In an example embodiment, the controller is configured to execute the executable instructions via the at least one processing element to further cause the controller to perform determining the determined route using a route-finding algorithm.

In an example embodiment, the confinement apparatus is a multi-domain confinement apparatus, the entanglement location is disposed in an entanglement domain of the multi-domain confinement apparatus, the first and second interaction locations are disposed in one or more interaction domains of the multi-domain confinement apparatus, and the first e-bit is routed to the first interaction location through a routing domain of the multi-domain confinement apparatus.

In an example embodiment, wherein the first e-bit is embodied by a first quantum object, the second e-bit is embodied by a second quantum object, the first data qubit is embodied by a third quantum object, and the second data qubit is embodied by a fourth quantum object; wherein the first reading operation is performed on the third quantum object and the second reading operation is performed on the fourth quantum object; and the controller is configured to execute the executable instructions via the at least one processing element to further cause the controller to perform causing the third quantum object to be transported out of the first interaction location; causing the first quantum object to assume the role of the first data qubit; causing the fourth quantum object to be transported out of the second interaction location; and causing the second quantum object to assume the role of the second data qubit.

In an example embodiment, the controller is configured to execute the executable instructions via the at least one processing element to further cause the controller to perform causing the third quantum object and the fourth quantum object to be transported to respective entanglement locations of one or more entanglement locations of the confinement apparatus.

In an example embodiment, the first e-bit is embodied by a first quantum object, the second e-bit is embodied by a second quantum object, the first data qubit is embodied by a third quantum object, and the second data qubit is embodied by a fourth quantum object; wherein the first reading operation is performed on the first quantum object and the second reading operation is performed on the second quantum object; and the controller is configured to execute the executable instructions via the at least one processing element to further cause the controller to perform causing the first quantum object to be transported out of the first interaction location; and causing the second quantum object to be transported out of the second interaction location.

In an example embodiment, the controller is configured to execute the executable instructions via the at least one processing element to further cause the controller to perform causing the first quantum object and the second quantum object to be transported to respective entanglement locations of one or more entanglement locations of the confinement apparatus.

According to still another aspect, a (multi-domain) quantum object confinement apparatus is provided. The quantum object confinement apparatus includes an entanglement domain comprising an entanglement domain confinement device, a routing domain comprising one or more routing domain confinement devices and an interaction domain comprising an interaction domain confinement device. The entanglement domain defines one or more entanglement locations, wherein the entanglement domain is configured for sets of e-bits to be entangled at respective entanglement locations. Each of the one or more routing domain confinement devices and the interaction domain confinement device are configured to enable quantum objects to pass there through at respective inter-layer routing locations. The interaction domain defines a plurality of interaction locations and is configured for [data qubit]-[e-bit] pairs to be interacted at respective interaction locations.

In an example embodiment, each of one or more layers of the routing domain and the interaction domain comprise one or more inter-layer routing locations configured for routing quantum objects between adjacent layers.

In an example embodiment, each domain of the multi-domain quantum object confinement apparatus comprises at least one layer or a portion thereof and each inter-layer routing location includes a respective through hole through a substrate of a respective layer of to enable the quantum objects to pass through the substrate at the inter-layer routing location.

In an example embodiment, each layer of the one or more layers of the routing domain is configured to perform a respective set of routing operations.

In an example embodiment, the routing domain comprises a first routing layer and a second routing layer that is adjacent to the first routing layer, the first routing layer is configured for performing a first set of routing operations and the second routing layer is configured for performing a second set of routing operations, the first set of routing operations comprising a first routing operation that is not part of the second set of routing operations and the second set of routing operations comprising a second routing operation that is not part of the first set of routing operations.

In an example embodiment, the interaction domain and the routing domain define a return path configured for transporting quantum objects from the interaction domain to the entanglement domain.

In an example embodiment, the entanglement domain is configured for sets of e-bits to be entangled at respective entanglement locations through the application of one or more quantum logic gates on respective sets of two or more quantum objects disposed at the respective entanglement locations.

In an example embodiment, the (multi-domain) quantum object confinement apparatus comprises two or more routing domains and two or more interaction domains, the two or more routing domains comprises a first routing domain disposed on a first side of the entanglement domain and a second routing domain disposed on a second side of the entanglement domain, the first side the entanglement domain being opposite the second side of the entanglement domain, and the two or more interaction domains comprise a first interaction domain disposed on the first side of the entanglement domain and a second interaction domain disposed on the second side of the entanglement domain.

In an example embodiment, a qubit may be routed to the first interaction domain from the entanglement domain via the first routing domain and a qubit may be routed to the second interaction domain from the entanglement domain via the second routing domain.

According to yet another aspect a quantum system and/or quantum computer is provided. The quantum system and/or quantum computer comprises a multi-domain confinement apparatus and a controller configured to control operation of one or more components of the quantum system and/or quantum computer. The multi-domain confinement apparatus includes an entanglement domain comprising an entanglement domain confinement device, a routing domain comprising one or more routing domain confinement devices and an interaction domain comprising an interaction domain confinement device. The entanglement domain defines one or more entanglement locations, wherein the entanglement domain is configured for sets of e-bits to be entangled at respective entanglement locations. Each of the respective routing domain confinement devices and the interaction domain confinement device are configured to enable quantum objects to pass there through at respective inter-layer routing locations. The interaction domain defines a plurality of interaction locations and is configured for [data qubit]-[e-bit] pairs to be interacted at respective interaction locations. The controller comprises a memory storing executable instructions and at least one processing element. The controller is configured to execute the executable instructions via the at least one processing element to cause the controller to perform causing a set of e-bits to be entangled at the respective entanglement locations, the set of e-bits comprising a first e-bit and a second e-bit; causing (a) routing, via the routing domain, of the first e-bit to a first interaction location of the plurality of interaction locations defined at least in part by the confinement apparatus and (b) routing, via the routing domain, the second e-bit to a second interaction location of the plurality of interaction locations defined at least in part by the confinement apparatus, wherein a first data qubit is disposed at the first interaction location and a second data qubit is disposed at the second interaction location; causing (a) interaction of the first e-bit and the first data qubit at the first interaction location and (b) interaction of the second e-bit and the second data qubit at the second interaction location; and causing (a) a first reading operation to be performed on one of the first data qubit or the first e-bit and (b) a second reading operation to be performed on one of the second data qubit or the second e-bit.

In an example embodiment, the routing domain comprises a plurality of layers where each layer corresponds to a respective routing domain confinement apparatus of the one or more routing domain confinement devices.

According to another aspect, a method for manufacturing a multi-layer confinement apparatus comprising a plurality of layers is provided. In an example embodiment, the method comprises (a) fabricating a first floor portion of a first confinement device on a first wafer; (b) fabricating a first ceiling portion of the first confinement device a second wafer; (c) bonding the first floor portion of the first confinement device to the first ceiling portion of the first confinement device using a plurality of first spacers; (d) removing a portion of the second wafer that is opposite the first ceiling portion of the first confinement device to form a first thin substrate with the first ceiling portion formed on a first surface of the first thin substrate; (e) fabricating a next floor portion of a next confinement device on a second surface of the first thin substrate, wherein the second side of the thin substrate is opposite the first side of the first thin substrate; (f) fabricating a next ceiling portion of a next confinement device on an additional wafer; (g) bonding the next floor portion of the next confinement device to the next ceiling portion of the next confinement device using a plurality of second spacers; and (h) removing a portion of the additional wafer that is opposite the next ceiling portion of the next confinement device to form a next thin substrate.

In an example embodiment, the method further comprises, prior to bonding the next floor portion of the next confinement device to the next ceiling portion of the next confinement device, forming one or more through holes through the first thin substrate from the second side of the first thin substrate through to the first side of the first thin substrate.

In an example embodiment, each of the one or more through holes corresponds to a respective inter-layer routing location and is configured to enable a quantum object to pass through the first thin substrate from a first confinement region defined by the first confinement apparatus to a next confinement region defined by the next confinement apparatus.

In an example embodiment, the method further comprises repeating steps (e), (f), (g), and (h) a plurality of times to form a multi-layer confinement apparatus comprising three or more confinement devices.

In an example embodiment, the multi-layer confinement apparatus is a multi-domain confinement apparatus having a plurality of domains and each confinement device of the three or more confinement devices corresponds to a respective domain of the plurality of domains.

In an example embodiment, a first layer of the multi-layer confinement apparatus is configured as an entanglement domain, one or more intermediate layers of the multi-layer confinement apparatus are collectively configured as a routing domain, and a final layer of the multi-layer confinement apparatus is configured as an interaction domain.

In an example embodiment, the method further comprises forming a final floor portion of a final confinement device on a second surface of an exposed thin substrate, wherein the exposed thin substrate has a respective ceiling portion of a previous confinement device formed thereon and the respective ceiling portion of the previous confinement device is bonded to a respective floor portion of the previous confinement device via a plurality of respective spacers.

In an example embodiment, the method further comprises bonding a cloud chip to the floor portion of the final confinement device using a plurality of final spacers.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 provides block diagram of an example QCCD-based quantum computer, in accordance with an example embodiment.

FIG. 2A provides a circuit diagram representing the performance of a remote quantum logic operation using a pair of entangled quantum objects, according to an example embodiment.

FIG. 2B provides a circuit diagram representing the performance of a remote quantum logic operation using a pair of entangled quantum objects, according to another example embodiment.

FIGS. 2C and 2D provide respective illustrations of how a single data qubit gate may be commuted through a two-data qubit quantum logic operation, in accordance with an example embodiment.

FIG. 3 provides a flowchart illustrating processes, procedures, and operations performed, for example, by a controller of a quantum computer, to perform a remote quantum logic operation using a pair of entangled quantum objects, according to an example embodiment.

FIGS. 4A-4D provide schematic diagrams illustrating respective steps of the flowchart illustrated in FIG. 3, in accordance with an example embodiment.

FIGS. 5A and 5B illustrate the performance of processes, procedures, and/or operations illustrated in FIG. 5C at time steps i – 1 and i, according to an example embodiment.

FIG. 5C is a flowchart illustrating processes, procedures, and operations performed, for example, by a controller of a quantum computer, to perform pipelined distribution of entangled pairs of quantum objects for the performance of quantum computations, according to an example embodiment.

FIG. 6 provides a schematic cross-sectional diagram of an example multi-layer confinement apparatus, in accordance with an example embodiment.

FIGS. 7 and 8 each illustrate a respective a layer of a routing domain configured to perform respective sets of routing operations, in accordance with an example embodiment.

FIG. 9 provides a schematic diagram of an example of a multi-domain confinement apparatus, in accordance with an example embodiment.

FIG. 10 provides a flowchart illustrating processes, procedures, and/or operations for fabricating an example multi-layer confinement apparatus, in accordance with an example embodiment.

FIGS. 11A-11F each provide a schematic cross-section of an example multi-layer confinement apparatus at a respective step in the fabrication thereof, in accordance with an example embodiment.

FIG. 12 provides a schematic diagram of an example controller of a quantum computer comprising an ion trap apparatus, in accordance with an example embodiment.

FIG. 13 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “substantially,” “generally,” and “approximately” refer to within appropriate engineering and/or manufacturing tolerances and/or within user measurement capabilities, unless otherwise indicated. Like numbers refer to like elements throughout.

QCCD-based quantum computers used confined quantum objects (e.g., ions and/or the like) as data qubits of the quantum computer. The quantum objects may be transported to different locations within the confinement apparatus that confines the quantum objects to enable the pairing of arbitrary pairs of quantum objects for interaction. For example, arbitrary pairs of quantum objects may be generated such that quantum logic operations may be performed on the arbitrary pairs of quantum objects. However, the transportation operations used to transport the quantum objects within the confinement apparatus amount for a significant amount of time required by a QCCD-based quantum computer for performing quantum computations. As a result, the throughput or bandwidth of QCCD-based quantum computers can be limited by the latency caused by transportation of the quantum objects. Thus, technical problem exists regarding how to increase the throughput or bandwidth of QCCD-based quantum computers so that QCCD-based quantum computers can solve problems more quickly.

Various embodiments disclosed herein provide technical solutions to these technical problems. For example, various embodiments provide for and/or enable the performance of remote quantum logic operations such that all-to-all connectivity of the quantum objects can be achieved without requiring transportation of data qubits. Moreover, various embodiments provide and/or enable the pipelined distribution of entangled sets of e-bits (e.g., a set or pair of quantum objects that have been initialized and then entangled with one another) such that remote quantum logic operations may be performed with high throughput, hiding the transportation latency. For example, various embodiments provide and/or enable QCCD-based quantum computers to perform quantum computations on a throughput limited time scale rather than a transportation latency limited time scale. Thus, various embodiments provide improvements to the technical fields of confinement apparatuses, quantum computers (in particular, QCCD-based quantum computers), and operation of quantum computers (in particular, operation of QCCD-based quantum computers).

For example, in various embodiments, an entangled set of e-bits is generated (e.g., at an entanglement location defined at least in part by a confinement apparatus). Respective e-bits of the set of e-bits are transported to respective interaction locations. Respective data qubits of a set of data qubits upon which the remote quantum logic operation is to be performed are located at and/or transported to the respective interaction locations. At each of the respective interaction locations, a respective data qubit is interacted with a respective e-bit and a measurement or reading of one of the data qubit or the e-bit at each respective interaction location is performed. Whichever of the respective e-bit or the respective data qubit is the measured or read is now considered a spent quantum object and removed from the interaction location (e.g., ejected from the confinement apparatus, returned to an entanglement location for reuse, and/or the like). Whichever of the respective e-bit or the respective data qubit was not measured or read, is now the data qubit at the interaction location. Thus, various embodiments provide methods, confinement apparatuses, controllers, quantum computers and/or systems, computer program products, and/or the like that use quantum teleportation to perform remote quantum logic operations.

In various embodiments, at each time step of the quantum circuit, one or more entangled sets of e-bits are generated and the respective e-bits of the existing entangled sets of e-bits are each moved one transportation step closer to the respective interaction location at which the respective e-bit will be used to perform a remote quantum logic operation. Each time step of the quantum circuit operation further includes performing one or more remote quantum logic operations. For example, the respective e-bit to be used to perform a remote quantum logic operation at time step i at a respective interaction location is, at time step i-1, transported to close to within one transportation step of the respective interaction location, in an example embodiment. Thus, during time step i, minimal transportation of the respective e-bit is required to bring the respective e-bit into proximity (e.g., in the same potential well) with the respective data qubit such that an interaction between the respective e-bit and the respective data qubit may be performed and/or caused to cause performance of the remote quantum logic operation. Moreover, this enables each time step of the quantum circuit to be performed with minimal transportation latency.

### Exemplary Quantum Computer System

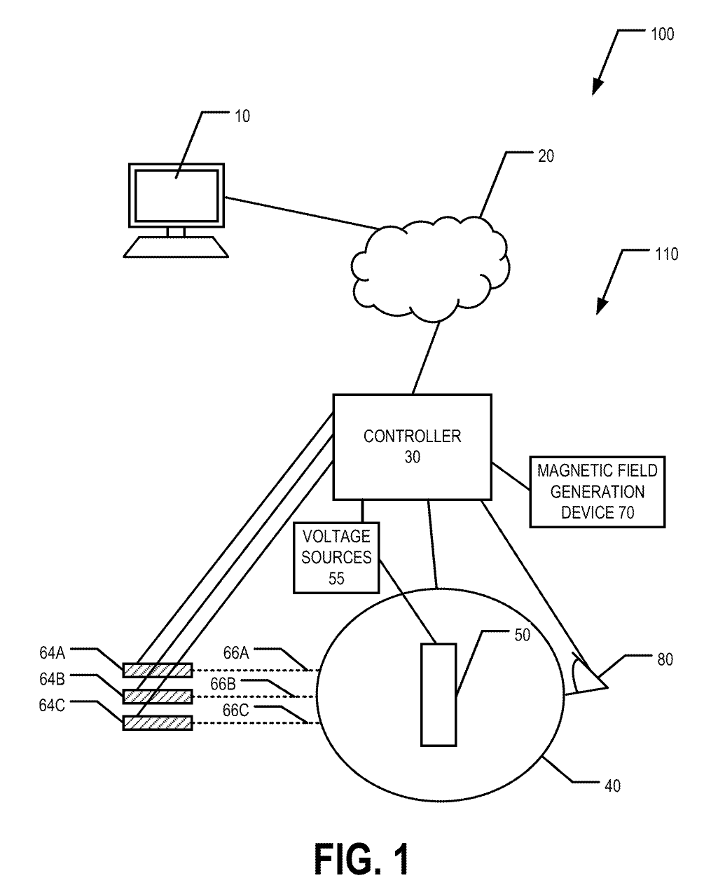

FIG. 1 provides a block diagram of an example QCCD-based quantum computer system 100, in accordance with various embodiments. In various embodiments, the quantum computer system 100 comprises a computing entity 10 and a quantum computer 110. In various embodiments, the quantum computer 110 comprises a controller 30, a cryogenic and/or vacuum chamber 40 enclosing a confinement apparatus 50 (e.g., an ion trap and/or the like), voltage sources 55, a magnetic field generation device 70, one or more manipulation sources 64 (e.g., 64A, 64B, 64C), photon detection system 80, and/or the like.

In various embodiments, the confinement apparatus 50 is configured to confine a plurality of quantum objects. For example, in various embodiments the quantum objects are neutral or ionic atoms; neutral, ionic, and/or multipole molecules; quantum dots; and/or other quantum particles. In various embodiments, the confinement apparatus 50 confines the plurality of quantum objects for use as data qubits of the quantum computer 110. In various embodiments, the quantum computer 110 comprises a plurality of potential drivers (e.g., voltage sources 55 and/or the like) used to control operation of the confinement apparatus 50. For example, the controller 30 is configured to control operation of the plurality of potential drivers (e.g., voltage sources 55) so as to control the operation of the confinement apparatus 50.

In an example embodiment, the one or more manipulation sources 64 may comprise one or more lasers (e.g., optical lasers, and/or the like), microwave field sources, and/or the like. In various embodiments, the one or more manipulation sources 64 are configured to manipulate and/or cause a controlled quantum state evolution of one or more quantum objects (e.g., data qubits) confined by the confinement apparatus 50. For example, in an example embodiment, wherein the one or more manipulation sources 64 comprise one or more lasers, the lasers may provide one or more laser beams and/or pulses to the confinement apparatus 50 within the cryogenic and/or vacuum chamber 40. In various embodiments, the manipulation sources 64 may be used to generate manipulation signals that are used to perform quantum logic operations (e.g., gate operations), cooling operations, leakage suppression operations, measurement and/or reading operations, and/or the like. In an example embodiment, the one or more manipulation sources 64 each provide a laser beam and/or other manipulation signal to the confinement apparatus 50 via a corresponding beam path system 66 (e.g., 66A, 66B, 66C). In various embodiments, at least one beam path system 66 comprises a modulator configured to modulate the manipulation signal being provided to the confinement apparatus 50 via the beam path system 66. In various embodiments, the manipulation sources 64, active components of the beam path systems 66 (e.g., modulators and/or the like), and/or other components of the quantum computer 110 are controlled by the controller 30.

In various embodiments, the magnetic field generation device 70 may comprise circuitry coupled to a voltage source (e.g., a current driver or voltage driver), one or more permanent magnets, and/or a combination thereof for generating a magnetic field experienced by quantum objects confined by the confinement apparatus 50. In various embodiments, the controller 30 is configured to control operation of the voltage source.

In various embodiments, the photon detection system 80 is configured to detect, measure, and/or capture photons emitted by one or more quantum objects confined by the confinement apparatus 50. For example, in various embodiments, the photon detection system 80 comprises one or more optical and/or photon detectors, such as photomultipliers, photodiodes, charge-coupled device (CCD) sensors/detectors, complementary metal oxide semiconductor (CMOS) sensors/detectors, and/or the like. In various embodiments, the photon detection system 80 may further comprise one or more diffractive and/or metamaterial optical components configured to direct photons emitted by the one or more quantum objects to at least one of the optical and/or photon detectors.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms, and/or the like into a computing language, executable instructions, command sets, and/or the like that the controller 30 can understand, execute, and/or implement.

In various embodiments, the controller 30 is configured to control potential drivers (e.g., voltage sources and/or the like) controlling the confinement apparatus 50 and/or confinement and transport of quantum objects within the confinement apparatus 50; a cryogenic system and/or vacuum system controlling the temperature, pressure, and/or other environmental parameters within the cryogenic and/or vacuum chamber 40; manipulation sources 64; beam path systems 66; and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the confinement apparatus 50. In various embodiments, the controller 30 is configured to receive signals from the photon detection system 80. In various embodiments, the quantum objects confined by the confinement apparatus 50 are used as data qubits of the quantum computer 110.

### Example Performance of a Remote Quantum Logic Operation

Various embodiments provide methods for performing remote quantum logic operations. For example, in various embodiments, quantum teleportation is used to perform remote quantum logic operations, such as two or more data qubit gates where the two or more data qubits are disposed at distinct locations of one or more confinement apparatuses (e.g., in different potential wells and/or the data qubits are separated from one another by at least 10 μm).

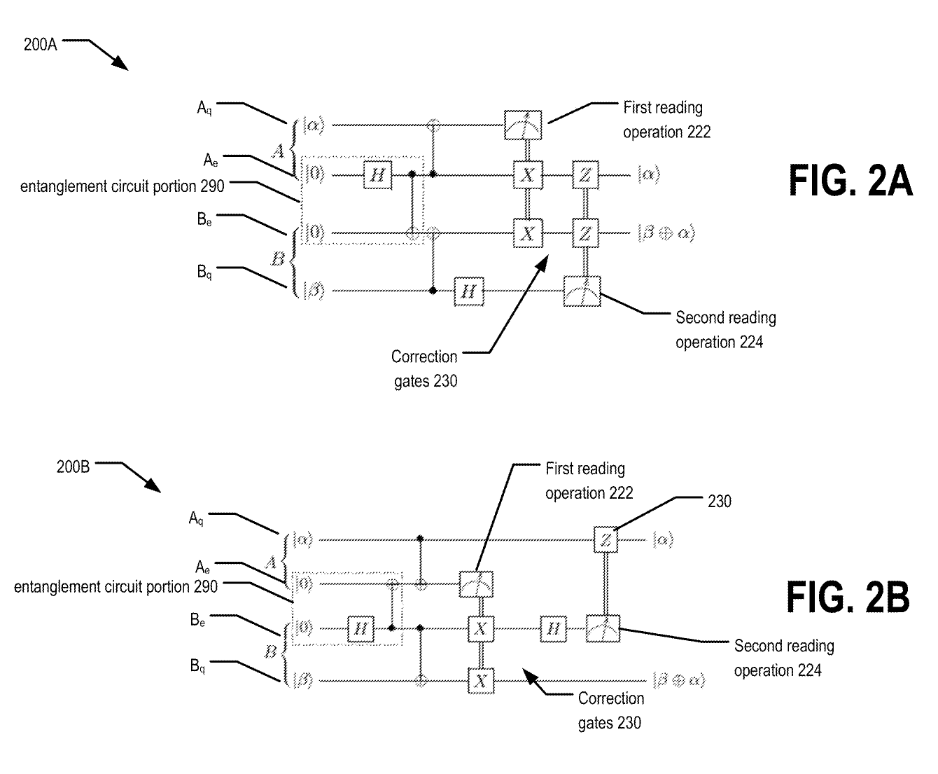

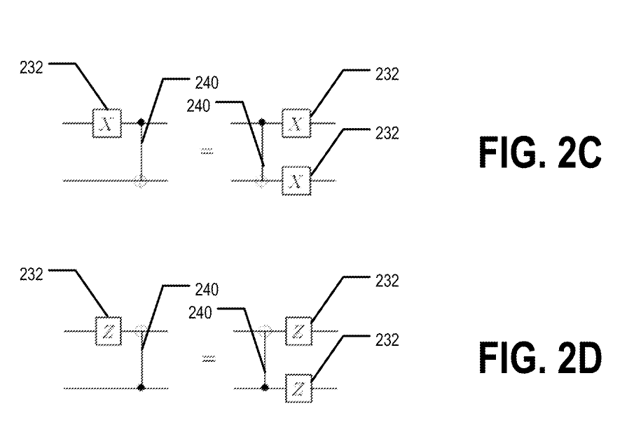

FIGS. 2A and 2B provide circuit diagrams of respective circuit portions for performing a remote quantum logic operation 200 (e.g., 200A, 200B). In the remote quantum logic operation, a set of qubits labeled as e-bits, first e-bit Aₑ and second e-bit Bₑ, are entangled with one another. The first e-bit Aₑ is transported to a first interaction location to interact with a first data qubit A_{q}. The second e-bit Bₑ is transported to a second interaction location to interact with a second data qubit B_{q}. The interactions of the first e-bit Aₑ with the first data qubit A_{q} and the second e-bit Bₑ with the second data qubit B_{q}, followed by the measurement and/or reading of one of the first e-bit Aₑ or the first data qubit A_{q} and the measurement and/or reading of one of the second e-bit Bₑ or the second data qubit B_{q}, results in the performance of the remote quantum logic operation. The illustrated remote quantum logic operation 200 is a remote CNOT two-data qubit gate where the first data qubit A_{q} is the control and the second data qubit B_{q} is the target. While the illustrated example remote quantum logic operation 200 is a remote CNOT two-data qubit gate, various other two or more data qubit gates (e.g., ZZ gates, gates formed based on unitary transformations of ZZ gates and/or CNOT gates, arbitrary two-data qubit gates drawn from the special unitary group of degree 4, and/or the like).

In various embodiments, the confinement apparatus 50 is configured to confine quantum objects. In various embodiments, the quantum objects are neutral or ionic atoms; neutral, ionic, and/or multipole molecules; quantum dots; and/or other quantum particles. A sub-space of the quantum states of the quantum objects is defined as a qubit space. In various embodiments, the qubit space includes two quantum states. In various embodiments, the quantum states of the qubit space are hyperfine states. In various embodiments, the quantum states of the qubit space are defined based on a z-projection of the angular momentum and/or spin of the quantum objects. These are referred to as z-based qubit states herein. For example, in various embodiments, the z-based qubit states include a first qubit state |0> and a second qubit state |1>.

The remote quantum logic operation 200A illustrated in FIG. 2A corresponds to an example embodiment where, after performance of the remote quantum logic operation, the quantum object embodying the first e-bit Aₑ takes over the role of the first data qubit A_{q}, the quantum object that had been the first data qubit A_{q} is measured and/or read and then deemed a spent quantum object, the quantum object embodying the second e-bit Bₑ takes over the role of the second data qubit B_{q}, and the quantum object that had been the second data qubit B_{q} is measured and/or read and then deemed a spent quantum object. The remote quantum logic operation 200B illustrated in FIG. 2B corresponds to an example embodiment, where the first e-bit Aₑ is measured and/or read and then considered a spent quantum object and the second e-bit Bₑ is measured and/or read and then considered a spent quantum object.

As shown in FIG. 2A, at the beginning of the remote quantum logic operation 200A, the first data qubit A_{q} is in quantum state |α> as a function of the quantum logic operations previously performed on the first data qubit A_{q} and the second data qubit B_{q} is in quantum state |β> as a function of the quantum logic operations previously performed on the second data qubit B_{q}. In various embodiments, the quantum states |α> and |β> are arbitrary superpositions of the first qubit state |0> and the second qubit state |1> and may also be entangled with other quantum objects in the circuit.

The first e-bit Aₑ and the second e-bitBₑ are each initialized into a qubit state (e.g., the |0> qubit state). In the illustrated embodiment, performing an entanglement circuit portion 290 includes performing a Hadamard gate on the first e-bit Aₑ to cause the first e-bit Aₑ to be in a quantum state that is a super position of the |0> qubit state and the |1> qubit state and then entangling the first e-bit Aₑ and the second e-bit Bₑ with one another via a CNOT gate where the first e-bit Aₑ is the control and the second e-bit Bₑ is the target. The joint state of the quantum objects embodying Aₑ and Bₑ is the entangled Einstein Podolsky and Rosen (EPR) state (|00>+|11>)/sqrt(2), and the pair of quantum objects Aₑ and Bₑ are the e-bits of the EPR pair.

The first e-bit Aₑ is then transported to a first interaction location defined at least in part by the confinement apparatus 50. The first data qubit A_{q} is either disposed at the first interaction location or is transported to the first interaction location. The second e-bit Bₑ is transported to a second interaction location defined at least in part by the confinement apparatus 50. The second data qubit B_{q} is either disposed at the second interaction location or transported to the second interaction location. An entangling gate (e.g., a CNOT gate) is performed on the first e-bit Aₑ and the first data qubit A_{q} at the first interaction location with the first e-bit Aₑ being the control and the first data qubit A_{q} being the target. An entangling gate (e.g., a CNOT gate) is performed on the second e-bit Bₑ and the second data qubit B_{q} at the second location with the second e-bit Bₑ being the target and the second data qubit B_{q} being the control. The entangling gate may be a CNOT gate, a ZZ gate, control-Z gate, a gate chosen from the group of special unitary operations of degree 4, or any other general entangling gate between two qubits.

Respective measurement and/or reading operations are performed on the first data qubit A_{q} and the second data qubit B_{q} to determine the respective quantum states thereof. In an example embodiment, a Hadamard gate is performed on the second data qubit B_{q} prior to the measurement and/or reading operation performed on the second data qubit B_{q}. As should be understood, performing a measurement and/or reading operation on a data qubit (or an e-bit) to determine the quantum state thereof causes the wavefunction of the data qubit (or e-bit) to collapse to a single state (e.g., either the first qubit state |0> or the second qubit state |1>). Thus, after performance of the respective measurement and/or reading operations, the quantum information stored by the first data qubit A_{q} and the second data qubit B_{q} is destroyed and the first and second data qubits are deemed to be spent quantum objects. The spent quantum objects may be ejected from the trap, reinitialized, used as an e-bit, and/or the like.

Correction gates 230 may be performed on the first e-bit Aₑ and the second e-bit Bₑ conditioned on measurement outcomes of the first and second data qubits A_{q} and B_{q} (illustrated by the double lines), and the correction gates 230 complete the performance of the remote quantum logic operation. For example, the correction gates 230 include classically conditioned quantum gates where one or more respective parameters of the quantum gates and/or whether respective gates are applied or not is determined based on the respective results of the measurement and/or reading operations. In various embodiments, the correction gates 230 are performed by tracking the correction gates 230 via the controller 30, rather than immediately and/or physically performing the correction gates 230. In various embodiments, the correction gates 230 may not need to be physically applied. Rather, the correction gates 230 may be tracked by the controller 30 and applied through (classical) software. For example, the correction gates 230 may be applied by modifying and/or updating a measurement and/or reading operation result in accordance with the tracked correction gates 230. For example, in various embodiments, the correction gates 230 comprise Pauli gates (Pauli X gates and Pauli Z gates, as illustrated in FIG. 2A). FIGS. 2C and 2D illustrate how Pauli gates 232 may be commuted through a two-qubit quantum logic operation 240, such as the illustrated example of a CNOT gate.

In general, Pauli gates may be commuted through any Clifford gates. Clifford gates are the elements of the Clifford group, a set of mathematical transformations which normalize the n-qubit Pauli group. In other words, a Clifford gate maps tensor products of Pauli matrices to tensor products of Pauli matrices through conjugation. Thus, in a Clifford-only circuit, the Pauli gates do not need to be physically performed.

Pauli gates affect measurement and/or reading operation results in predictable ways. For example, Pauli Z gates do not affect measurement and/or reading operations that are configured to determine a z-based qubit state. A Pauli X gate or a Pauli Y gate before a measurement and/or reading operation configured to determine a z-based qubit state flips the measurement result. For example, if the measurement result is |0>, the Pauli X gate or the Pauli Y gate flips the measurement result to |1>.

In various embodiments, Pauli gates can be combined with single-qubit rotations to result in other single-qubit rotations. These single-qubit rotations can then be applied as future single qubit gates or tracked by the controller 30. For example, a Pauli Z gate followed by a qubit rotation of polar angle θ and azimuthal angle φ is equivalent to a qubit rotation of polar angle -θ and azimuthal angle φ followed by a Pauli Z gate. Similarly, a Pauli X gate followed by a qubit rotation of polar angle θ and azimuthal angle φ is equivalent to a qubit rotation of polar angle θ and azimuthal angle -φ followed by a Pauli X gate. Additionally, a Pauli Y gate followed by a qubit rotation of polar angle θ and azimuthal angle φ is equivalent to a qubit rotation of polar angle -θ and azimuthal angle -φ followed by a Pauli Y gate.

In various embodiments, only Clifford two or more qubit gates are used such that the correction gates 230 may be tracked by the controller 30 and applied through software corrections to the measurement and/or reading operations.

In an example embodiment depicted in FIG. 2A where the remote CNOT is performed, the quantum object that embodies the first e-bit Aₑ is then considered to be the first data qubit A_{q} and has quantum state |α>. The quantum object that embodies the second e-bit Bₑ is then considered to be the second data qubit B_{q} and has quantum state |β ⊕ α>, consistent with the CNOT operation between states |α> and |β>.

The remote quantum logic operation 200B illustrated in FIG. 2B corresponds to an example embodiment where, after performance of the remote quantum logic operation, the quantum object embodying first data qubit A_{q} continues to embody the first data qubit A_{q} after performance of the remote quantum logic operation, the quantum object that had been the first e-bit Aₑ is measured and/or read and then deemed a spent quantum object, the quantum object embodying the second data qubit B_{q} continues to embody the second data qubit B_{q} after performance of the remote quantum logic operation, and the quantum object that had been the second e-bit Bₑ is measured and/or read and then deemed a spent quantum object. As shown in FIG. 2B, at the beginning of the remote quantum logic operation 200B, the first data qubit A_{q} is in quantum state |α> as a function of the quantum logic operation previously performed on the first data qubit A_{q} and the second data qubit B_{q} is in quantum state |β> as a function of the quantum logic operation previously performed on the second data qubit B_{q}. In various embodiments, the quantum states |α> and |β> are arbitrary superpositions of the first qubit state |0> and the second qubit state |1> and may also be entangled with other data qubits in the circuit.

The first e-bit Aₑ and the second e-bitBₑ are each initialized into a qubit state (e.g., the |0> qubit state). In the illustrated embodiment, performing an entanglement circuit portion 290 includes performing a Hadamard gate on the second e-bit Bₑ to cause the second e-bit Bₑ to be in a quantum state that is a super position of the |0> qubit state and the |1> qubit state and then entangling the first e-bit Aₑ and the second e-bit Bₑ with one another via a CNOT gate where the first e-bit Aₑ is the target and the second e-bit Bₑ is the control. The joint state of the quantum objects embodying Aₑ and Bₑ is the entangled Einstein Podolsky and Rosen (EPR) state, and the pair of quantum objects Aₑ and Bₑ are the e-bits of the EPR pair.

The first e-bit Aₑ is then transported to a first interaction location defined at least in part by the confinement apparatus 50. The first data qubit A_{q} is either disposed at the first interaction location or is transported to the first interaction location. The second e-bit Bₑ is transported to a second interaction location defined at least in part by the confinement apparatus 50. The second data qubit B_{q} is either disposed at the second interaction location or transported to the second interaction location. An entangling gate (e.g., a CNOT gate) is performed on the first e-bit Aₑ and the first data qubit A_{q} at the first interaction location with the first e-bit Aₑ being the target and the first data qubit A_{q} being the control. An entangling gate (e.g., a CNOT gate) is performed on the second e-bit Bₑ and the second data qubit B_{q} at the second location with the second e-bit Bₑ being the control and the second data qubit B_{q} being the target.

Respective measurement and/or reading operations are performed on the first e-bit Aₑ and the second e-bit Bₑ to determine the respective quantum states thereof. In various embodiments, a Hadamard gate is performed on the second e-bit Bₑ prior to the measurement and/or reading operation being performed on the second e-bit Bₑ. As should be understood, performing a measurement and/or reading operation on a e-bit (or a data qubit) to determine the quantum state thereof causes the wavefunction of the e-bit (or data qubit) to collapse to a single state (e.g., either the first qubit state |0> or the second qubit state |1>). Thus, after performance of the respective measurement and/or reading operations, the quantum information stored by the first e-bit Aₑ and the second e-bit Bₑ is destroyed and the first and second e-bits are deemed to be spent quantum objects. The spent quantum objects may be ejected from the trap, reinitialized, used as e-bits, and/or the like.

Correction gates 230 may be performed on the first data qubit A_{q} and the second data qubit B_{q} conditioned on measurement outcomes (illustrated by the double lines). Correction gates 230 complete the performance of the remote quantum logic operation. For example, the correction gates 230 include classically conditioned quantum gates where one or more respective parameters of the quantum gates and/or whether respective gates are applied or not is determined based on the respective results of the measurement and/or reading operations. In various embodiments, the correction gates 230 are performed by tracking the correction gates 230 via the controller 30, rather than immediately and/or physically performing the correction gates 230. In various embodiments, the correction gates 230 may not need to be physically applied. Rather, the correction gates 230 may be tracked by the controller 30 and applied through (classical) software. For example, the correction gates 230 may be applied by modifying and/or updating a measurement and/or reading operation result in accordance with the tracked correction gates 230. For example, in various embodiments, the correction gates 230 comprise Pauli gates (Pauli X gates and Pauli Z gates, as illustrated in FIG. 2B).

The quantum object that embodies the first data qubit A_{q} then continues to be the first data qubit A_{q} and the quantum object that embodies the second data qubit B_{q} then continues to be the second data qubit B_{q}.

In the illustrated embodiments in FIGS. 2A and 2B, the e-bits are entangled via a Hadamard gate and a CNOT to produce the EPR state (|00>+|11>)/sqrt(2) and CNOT gates are applied locally between each e-bit and each data qubit to facilitate a remote CNOT gate between data qubits (either leaving the quantum information within the data qubits and discarding the e-bits as in FIG. 2B or teleporting the quantum information to the e-bits, which take the place of the data qubits after discarding the former data qubits as in FIG. 2A). In other embodiments, the pair of e-bits may be formed into another entangled resource state [e.g., one of the other Bell states (|01>+|10>)/sqrt(2), (|01>-|10>)/sqrt(2), or (|00>-|11>)/sqrt(2)], and the local gating between each e-bit and its respective target data qubit may be different than the CNOT gate (e.g., the controlled phase gate CZ, the ZZ gate, or any two- qubit gate chosen from the class of special unitary group of degree 4 operators), and the correction gates conditioned on measurement outcomes (applied either directly or through tracking in the control software) may be different than those shown in FIGS. 2A or 2B in order to effectuate a different remote teleported entangling two-qubit gate between data qubits (e.g., any arbitrary two-qubit gate chosen from the class of special unitary group of degree 4 operators).

While FIG. 2A illustrates an example embodiment where both of the data qubits A_{q} and B_{q} are measured and/or read and then both of the e-bits take over as the respective data qubits and FIG. 2B illustrates an example embodiment where both e-bits Aₑ and Bₑ are measured and/or read, embodiments are contemplated where one data qubit is measured and/or read and one e-bit is measured and/or read. For example, in an example embodiment, the first data qubit A_{q} is measured and/or read, the second e-bit Bₑ is measured and/or read, and the quantum object embodying the first e-bit Aₑ takes over the role of the first data qubit A_{q}. In another example, the first e-bit Aₑ is measured and/or read, the second data qubit B_{q} is measured and/or read, and the quantum object embodying the second e-bit Bₑ takes over the role of the second data qubit B_{q}.

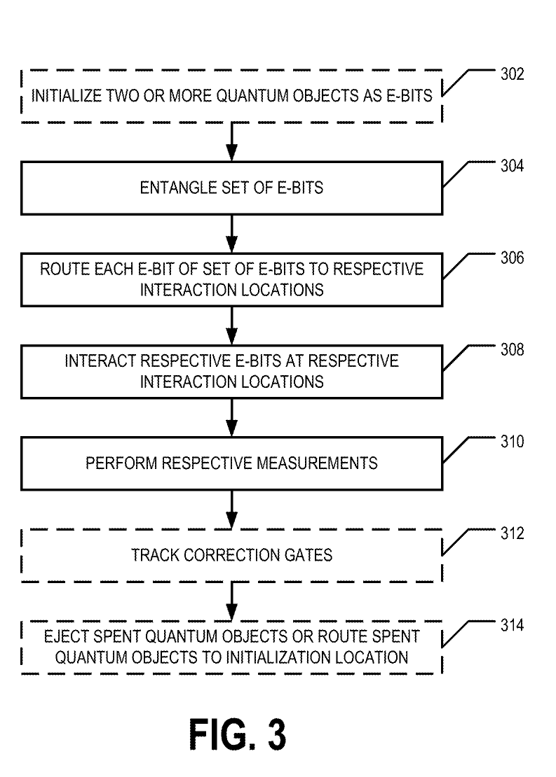

FIG. 3 provides a flowchart illustrating various processes, procedures, operations, and/or the like performed by a controller 30 of a quantum computer 110 to cause the quantum computer 110 to perform a remote quantum logic operation, such as remote quantum logic operation 200. Starting at step 302, the controller 30 controls operation of one or more components of the quantum computer 110 (e.g., potential drivers, manipulation sources, and/or the like) to cause one or more quantum objects to be confined by the confinement apparatus 50 and disposed at one or more respective initialization locations defined (at least in part) by the confinement apparatus 50. In an example embodiment, the initialization of the one or more quantum objects causes the quantum objects to be in known one of the qubit states (e.g., in the |0> qubit state, in an example embodiment).

At step 304, the controller 30 controls operation of one or more components of the quantum computer 110 (e.g., potential drivers, manipulation sources, and/or the like) to cause sets of two or more initialized quantum objects to be entangled to form an entangled set of e-bits. In an example embodiment, the controller 30 controls operation of the one or more components of the quantum computer 110 to cause a pair of initialized quantum objects to be entangled to form an entangled set of e-bits. The entangled set of e-bits comprises two or more quantum objects that have been entangled with one another. For example, in an example embodiment, an entanglement circuit portion 290 is performed on the set of two or more initialized quantum objects to form an entangled set of e-bits.

In various embodiments, the two or more quantum objects are entangled with one another to form the entangled set of e-bits and an entanglement location that is defined, at least in part, by the confinement apparatus 50. In various embodiments, the entanglement location is co-located with the initialization location. In various embodiments, the initialized quantum objects are transported from the initialization location to the entanglement location between the performance of the initialization of the quantum objects and the forming of the entangled set of e-bits.

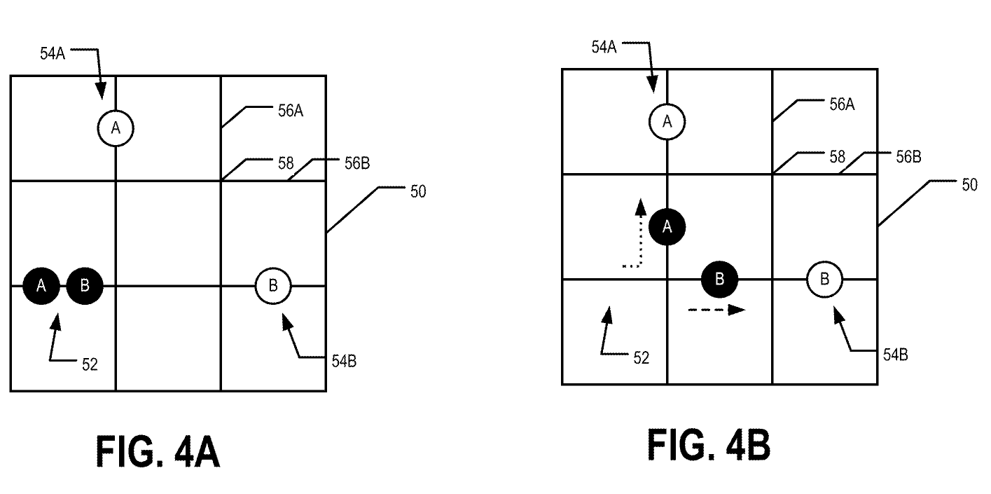

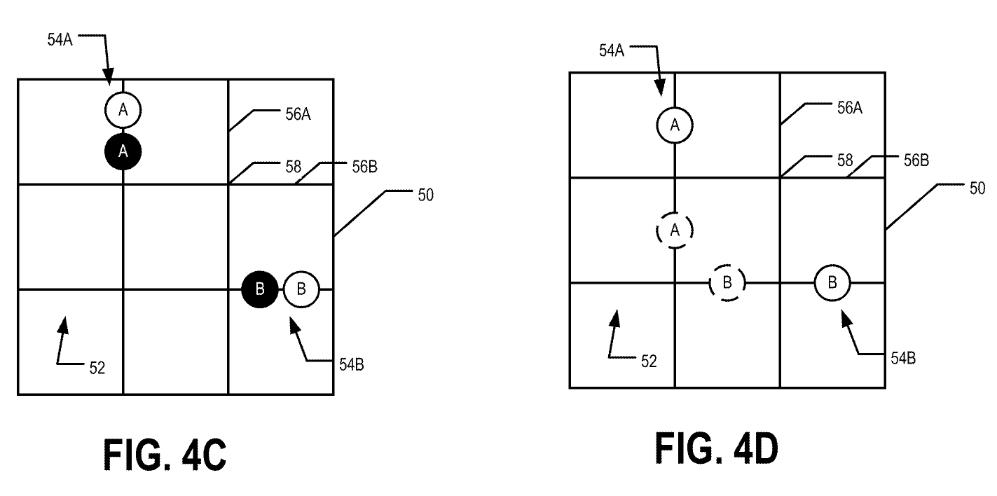

FIG. 4A illustrates an example entangled set of e-bits comprising e-bits Aₑ and Bₑ as the filled circles. For example, a first quantum object and a second quantum objects are entangled to form the entangled set of e-bits such that the first quantum object is now the first e-bit Aₑ and the second quantum object is now the second e-bit Bₑ.

The entangled set of e-bits is formed at the entanglement location 52 defined at least in part by the confinement apparatus 50. The confinement apparatus 50 comprises and/or defines a plurality of one-dimensional trapping regions 56 (e.g., 56A, 56B) that are linked and/or connected to respective other one-dimensional trapping regions via junctions 58. A first data qubit A_{q}, embodied by a third quantum object, is illustrated by the open circle located at a first interaction location 54A. A second data qubit B_{q}, embodied by a fourth quantum object, is illustrated by the open circle located at a second interaction location 54B.

Continuing with FIG. 3, the controller 30 controls operation of one or more components (e.g., potential drivers) of the quantum computer 110 to cause respective e-bits of the entangled set of e-bits to be routed and/or transported to respective interaction locations. For example, as shown in FIG. 4B, the first e-bit Aₑ may be routed and/or transported from the entanglement location 52 to the first interaction location 54A and the second e-bit Bₑ may be routed and/or transported from the entanglement location 52 to the second interaction location 54B.

In various embodiments, the controller 30 is configured to determine respective routes for the respective e-bits of the entangled set of e-bits to the respective interaction locations. For example, the controller 30 may be configured to execute a routing algorithm to determine a lowest cost route from an entanglement location to a respective interaction location. In various embodiments, the cost of a route may take into account various factors such as total distance, number of junction traversals, number other quantum objects encountered along the route (e.g., the number of times a quantum object would need to be transported past another quantum object located on a same one-dimensional trapping region), and/or the like. For example, a path-finding algorithm such as Dijkstra’s algorithm (or another path finding algorithm) may be used to determine respective routes for each e-bit of the entangled set of e-bits. The controller 30 may the control operation of the potential drivers, for example, to cause the respective e-bits to traverse the respective routes.

Continuing with FIG. 3, at step 308, the controller 30 controls operation of one or more components of the quantum computer 110 (e.g., potential drivers, manipulation sources, and/or the like) to perform the remote quantum logic operation. For example, the controller 30 causes respective interactions between the respective e-bits and the respective data qubits at the respective interaction locations. For example, as illustrated in FIG. 4C, the first e-bit Aₑ is disposed at the first interaction location 54A. The first data qubit A_{q} is also disposed at the first interaction location 54A. The second e-bit Bₑ and the second data qubit B_{q} are both disposed at the second interaction location 54B. The first interaction location 54A and the second interaction location 54B are distinct and separated from one another so that the first data qubit A_{q} and the second data qubit B_{q} do not directly interact with one another.

In various embodiments, the interaction between the first e-bit Aₑ and the first data qubit A_{q} is mediated and/or caused by one or more manipulation signals (e.g., laser beams, laser pulses, microwave signals, microwave pulses) and/or magnetic field gradients. For example, a two data qubit gate (e.g., an entangling gate; a CNOT gate in the example embodiments illustrated in FIGS. 2A and 2B) is performed on the first e-bit Aₑ and the first data qubit A_{q} at the first interaction location to cause the interaction of the first e-bit Aₑ and the first data qubit A_{q}. Similarly, a two data qubit gate is performed on the second e-bit Bₑ and the second data qubit B_{q} at the second interaction location to cause the interaction of the second e-bit Bₑ and the second data qubit B_{q}.

Continuing with step 310 shown in FIG. 3, the controller 30 controls operation of one or more components of the quantum computer 110 (e.g., potential drivers, manipulation sources, photon detector system, and/or the like) to perform respective measurement and/or reading operations. For example, in an example embodiment, a measurement and/or reading operation is performed on the first data qubit A_{q} and a measurement and/or reading operation is performed on the second data qubit B_{q}. In another example embodiment, a measurement and/or reading operation is performed on the first e-bit Aₑ and a measurement and/or reading operation is performed on the second e-bit Bₑ.

In various embodiments, performing a measurement and/or reading operation comprises causing a manipulation measurement signal (e.g., laser beam and/or train of laser pulses) to be incident on the quantum object to be measured and/or read. For example, the controller 30 may control operation of one or more manipulation sources 64 to cause one or more manipulation measurement signals to be incident on a quantum objected to be measured and/or read. The photon detection system then collects, captures, detects, samples, and/or measures any photons generated by the quantum object in response to the manipulation measurement signal(s) being incident thereon. For example, in an example embodiment, if the quantum object is in the first qubit state |0>, the quantum object will fluoresce in response to the manipulation measurement signal being incident thereon and if the quantum object is in the second qubit state |1>, the quantum object will not fluoresce in response to the manipulation measurement signal being incident thereon. Thus, the photon detection system 80 may be configured to provide a respective signal (e.g., an electrical signal) corresponding to the number of photons detected by the photon detection system 80 to the controller 30 (e.g., via an A/D converter of the controller 30). Based on electrical signal received by the controller 30 (e.g., and generated by the photon detection system 80), the controller 30 determines the quantum state of the measured and/or read quantum object.

At step 312, the controller 30 tracks the correction gates 230 of the remote quantum logic operation. For example, the controller 30 comprises a classical (e.g., semiconductor-based) memory that stores a classical qubit registry and/or quantum object database. The classical qubit registry and/or quantum object database includes respective records corresponding to each quantum object. For example, a record corresponding to a qubit may include a qubit identifier configured to identify the qubit with respect to a data qubit of a quantum circuit being performed by the quantum computer 110, quantum object identifier configured to identify the quantum object currently embodying the data qubit, a location tracker for the qubit, a phase accumulator for the qubit, a heat accumulator for the qubit, a correction gate tracker for the qubit, and/or the like for storing information corresponding to the qubit. For example, the controller 30 may update the respective correction gate trackers of the first and second data qubits, as appropriate for the remote quantum logic operation. For example, in an example embodiment where the measurement and/or reading operations were performed on the first and second data qubit, and the quantum objects previously embodying the first and second e-bits take on the respective roles of the first and second data qubits, the respective records may be updated to reflect the phase accumulator, heat accumulator, quantum object identifier, and/or other information stored in the record as appropriate.

At step 314, the controller 30 controls one or more components of the quantum computer 110 (e.g., the potential drivers and/or the like) to cause the spent quantum objects to be removed from the respective interaction locations. When a quantum object is measured and/or read, the quantum information stored thereby is destroyed as a result of the wavefunction of the quantum object collapsing to a single state. Thus, whichever quantum objects were subject to the respective measurement and/or reading operations are considered spent quantum objects.

For example, when the first data qubit A_{q} and the second data qubit B_{q} are measured and/or read by the respective measurement and/or reading operations, the third quantum object (previously embodying the first data qubit A_{q}) and the fourth quantum object (previously embodying the second data qubit B_{q}) are deemed to be spent quantum objects. The first quantum object (previously embodying the first e-bit Aₑ) takes on the role of the first data qubit A_{q} and the second quantum object (previously embodying the second e-bit Bₑ) takes on the role of the second data qubit B_{q}.

In another example, when the first e-bit Aₑ and the second e-bit Bₑ are measured and/or read by the respective measurement and/or reading operations, the first quantum object (previously embodying the first e-bit Aₑ) and the second quantum object (previously embodying the second e-bit Bₑ) are deemed to be spent quantum objects. The third quantum object continues to embody the first data qubit A_{q} and the fourth quantum object continues to embody the second data qubit B_{q}.

The spent quantum objects are removed from the respective interaction locations 54. For example, the spent quantum objects may be transported back to an initialization location and/or entanglement location such that the spent quantum objects may be recycled as e-bits, ancilla qubits, data qubits, and/or the like. In an example embodiment, the spent quantum objects are transported to a respective ejection location and are ejected from the confinement apparatus 50. FIG. 4D illustrates the first and second spent quantum objects (illustrated as the dashed line circles) being removed from the respective interaction locations 54 while the quantum objects embodying the first and second data qubits remain at the respective interaction locations 54. As should be understood, in an example embodiment, the first and second data qubits may also be removed from the respective interaction locations, as appropriate for the application.

### Example Pipelined Performance of Remote Quantum Logic Operations

In various embodiments, a plurality of remote quantum logic operations may be performed during a time step of the performance of quantum circuit. For example, a quantum computer 110 may perform a quantum circuit. The quantum circuit is divided into a plurality of time steps. Each time step may include the performance of multiple remote quantum logic operations substantially in parallel and/or at least partially overlapping in time. For example, during a time step i of a quantum circuit, where i is positive integer, a remote quantum logic operation may be performed on first and second data qubits A_{q} and B_{q} (e.g., mediated by a first entangled set of e-bits including first and second e-bits Aₑ and Bₑ) and, also during time step i, a remote quantum logic operation may be performed on third and fourth data qubits C_{q} and D_{q} (e.g., mediated by a second entangled set of e-bits including third and fourth e-bits Cₑ and Dₑ).

Similarly, a plurality of remote quantum logic operations may be performed during time step i – 1 and i +1. For example, one or more remote quantum logic operations may be performed for any and/or each time step of a quantum circuit, in various embodiments. Thus, various embodiments provide a pipelined architecture to enable performance of a plurality of remote quantum logic operations at any and/or each time step of a quantum circuit such that latency due to transportation of quantum objects is not a bandwidth and/or throughput limiting feature of the quantum computer 110.

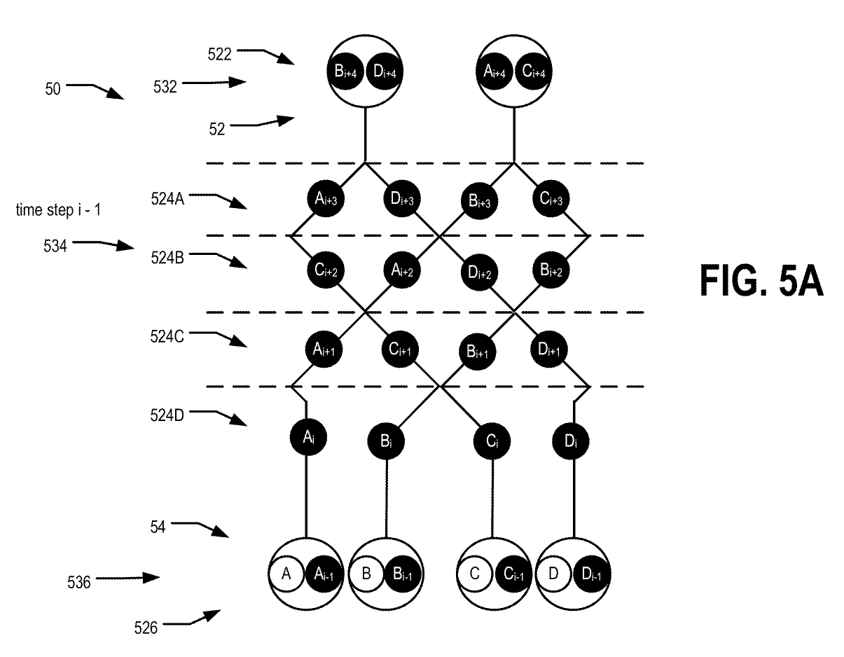

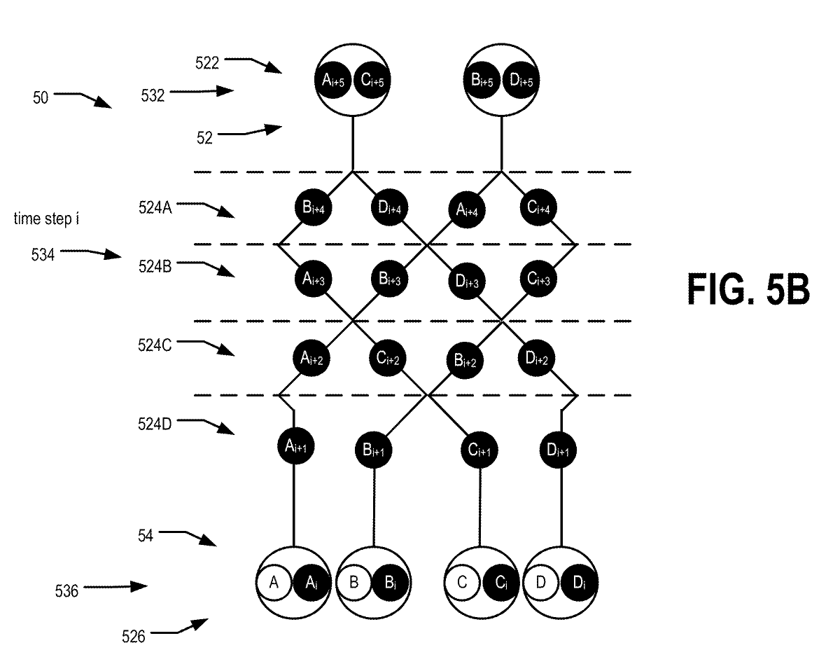

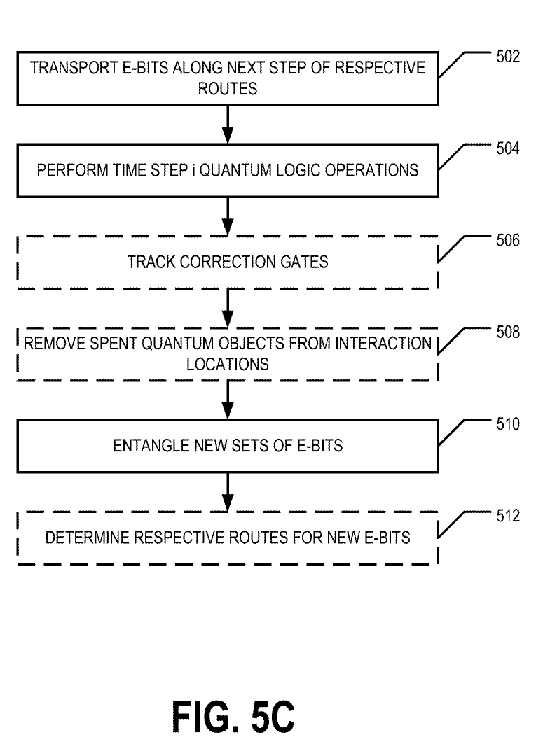

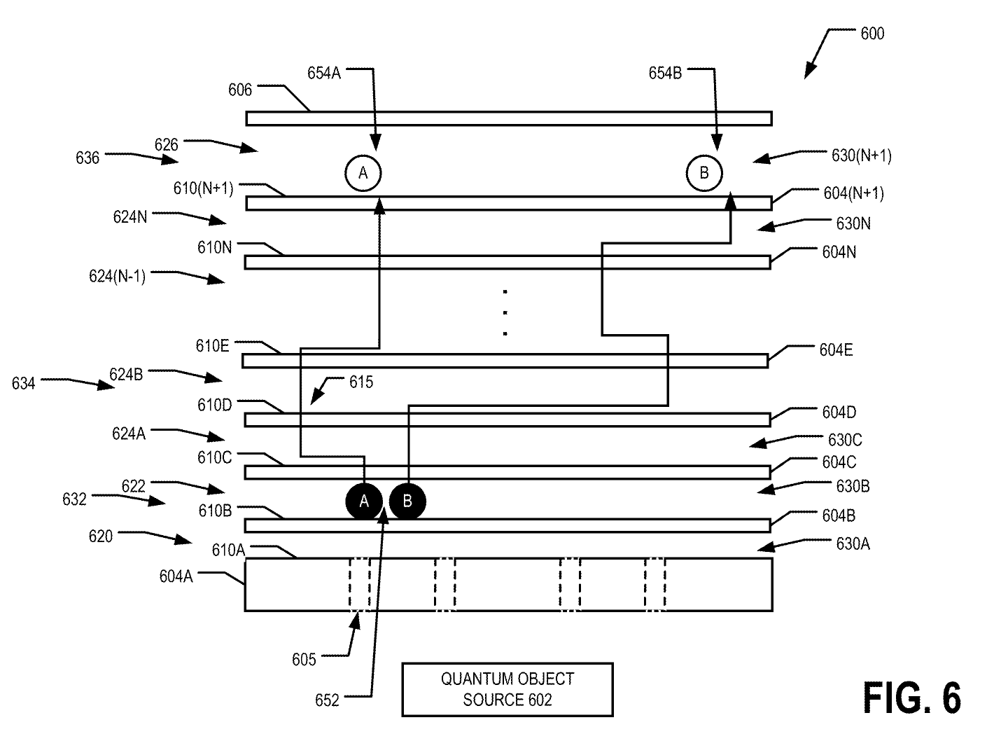

For example, FIGS. 5A and 5B illustrate an example confinement apparatus 50 that includes an entanglement domain 532 (comprising and/or embodied as entanglement layer 522) comprising and/or defining two entanglement locations 52, a routing domain 534, and an interaction domain 536 (comprising and/or embodied as interaction layer 526) comprising and/or defining four interaction locations 54. The routing domain 534 is configured to enable routing of an e-bit from an arbitrary entanglement location 52 to an arbitrary interaction location 54. In the illustrated embodiment, the routing domain 534 includes routing layers 524A, 524B, 524C, and 524D.

FIG. 5A illustrates the locations of a plurality of data qubits and a plurality of e-bits at time step i - 1 of a quantum circuit and FIG. 5B illustrates the locations of a plurality of data qubits and a plurality of e-bits at time step i of a quantum circuit. In the illustrated embodiment, four time steps of the quantum circuit are needed for an e-bit to be transported from a respective entanglement location 52 to a respective interaction location 54, showing the latency of the process. However, the throughput of gating operations between data qubits in the interaction domain is four per time step and not limited by latency. In various embodiments, the number of time steps needed to transport an e-bit from a respective entanglement location 52 to a respective interaction location 54 (i.e., the latency) will depend on the layout of the confinement apparatus and the speed with which the transportation operations may be performed, among other possible factors. However, the throughput can be maintained as constant as the system scales by using this pipelining method.

FIG. 5A illustrates the locations of four data qubits (shown as the open circles labeled A, B, C, and D) each disposed at a respective interaction location 54 at time step i - 1. E-bits (shown as the filled circles) scheduled and/or configured for interaction with respective qubits at time step i – 1 are disposed at the respective interaction locations 54. E-bits scheduled and/or configured for interaction with respective qubits at time step i are only a single layer away from the interaction domain (e.g., the interaction layer 526 of the confinement apparatus 50 configured as the interaction domain 536). For example, the e-bits scheduled and/or configured for interaction with respective qubits at time step i are disposed at routing layer 524D. E-bits scheduled and/or configured for interaction with respective qubits at time step i+1 are being transported through the routing layers 524 of the routing domain 534 and are two time steps away from the interaction layer 526 (e.g., disposed at routing layer 524C). E-bits scheduled and/or configured for interaction with respective qubits at time step i+2 are being transported through the routing layers 524 of the routing domain 534 and are three time steps away from the interaction layer 526 (e.g., disposed at routing layer 524B). E-bits scheduled and/or configured for interaction with respective qubits at time step i+3 are being transported through the routing layers 524 of the routing domain 534 and are four time steps away from the interaction layer 526 (e.g., disposed at routing layer 524A). E-bits scheduled and/or configured for interaction with respective qubits at time step i + 4 are being entangled into entangled sets of e-bits at respective entanglement locations 52 and are five time steps away from the interaction layer 526 (e.g., disposed at the entanglement layer 522 configured as the entanglement domain 532).

FIG. 5B illustrates the locations of four data qubits (shown as the open circles labeled A, B, C, and D) each disposed at a respective interaction location 54 at time step i. E-bits scheduled and/or configured for interaction with respective qubits at time step i+1 are only a single layer away from the interaction domain 536 (e.g., at the interaction layer 526 configured as the interaction domain 536). For example, the e-bits scheduled and/or configured for interaction with respective qubits at time step i+1 are disposed at routing layer 524D. E-bits scheduled and/or configured for interaction with respective qubits at time step i+2 are being transported through the routing layers 524 of the routing domain 534 and are two time steps away from the interaction domain 536 (e.g., disposed at routing layer 524C). E-bits scheduled and/or configured for interaction with respective qubits at time step i+3 are being transported through the routing layers 524 of the routing domain 534 and are three time steps away from the interaction domain 536 (e.g., disposed at routing layer 524B). E-bits scheduled and/or configured for interaction with respective qubits at time step i+4 are being transported through the routing layers 524 of the routing domain 534 and are four time steps away from the interaction domain 536 (e.g., disposed at routing layer 524A). E-bits scheduled and/or configured for interaction with respective qubits at time step i + 5 are being entangled into entangled sets of e-bits at respective entanglement locations 52 of the entanglement domain 532 (e.g., at the entanglement layer 522 configured as the entanglement domain 532) and are five time steps away from the interaction domain 536.

Thus, as shown by FIG. 5A and 5B, one or more remote quantum logic operations may be performed for any and/or each time step of a quantum circuit. For example, the pipelined architecture of the system enables performance of a plurality of remote quantum logic operations at any and/or each time step of a quantum circuit such that latency due to transportation of quantum objects is not a bandwidth and/or throughput limiting feature of the quantum computer 110.

FIG. 5C provides a flowchart illustrating processes, procedures, operations, and/or the like performed during a time step i of a quantum circuit that uses remote quantum logic operations to perform quantum calculations. For example, a controller 30 may perform the processes, procedures, operations, and/or the like shown in FIG. 5C repeatedly (e.g., once for each time step of the quantum circuit, for example) to cause the quantum calculation encoded by the quantum circuit to be performed.

Starting at step 502, the controller 30 controls operation of one or more components of the quantum computer 110 (e.g., potential drivers) to cause the existing e-bits to be transported along the next step of the respective routes. For example, during one or more previous time steps, one or more entangled sets of e-bits are generated (e.g., one or more sets of e-bits are entangled at one or more respective entanglement locations). At each time step, the e-bits of the one or more entangled sets of e-bits are transported one step along respective routes. For example, the respective route for a respective e-bit is a route or path from the entanglement location where the respective e-bit was entangled with one or more other e-bits to generate an entangled set of e-bits to a respective interaction location where the respective e-bit is to be interacted with a respective data qubit to cause performance of a remote quantum logic operation.

At step 504 occurring in parallel with one or more other steps of FIG. 5C (e.g., step 502, 506, 508, 510, 512, and/or the like), the time step i quantum logic operations are performed. For example, the controller 30 controls operation of one or more components of the quantum computer 110 (e.g., potential drivers, manipulations signals, photon detector system, and/or the like) to cause the quantum logic operations of time step i of the quantum circuit to be performed. In various embodiments, the quantum logic operations of time step i of the quantum circuit may include one or more single data qubit gates, one or more two or more data qubit gates, measurement and/or reading operations, and/or the like. In various embodiments, at least one of the one or more two or more data qubit gates is performed as a remote quantum logic operation. In various embodiments, at least some of the quantum logic operations of time step i of the quantum circuit are performed at respective interaction locations.

At step 506, the controller 30 tracks the correction gates corresponding to the quantum logic operations performed at step 504. For example, the controller 30 comprises a classical (e.g., semiconductor-based) memory that stores a classical data qubit registry and/or quantum object database. The classical data qubit registry and/or quantum object database includes respective records corresponding to each quantum object. For example, a record corresponding to a data qubit may include a data qubit identifier configured to identify the data qubit with respect to a data qubit of a quantum circuit being performed by the quantum computer 110, quantum object identifier configured to identify the quantum object currently embodying the data qubit, a location tracker for the data qubit, a phase accumulator for the data qubit, a heat accumulator for the data qubit, a correction gate tracker for the data qubit, and/or the like for storing information corresponding to the data qubit. For example, the controller 30 may update the respective correction gate trackers of the data qubits involved in remote quantum logic operations and/or other quantum logic operations (e.g., single data qubit gates, non-remote two or more data qubit gates, and/or the like), as appropriate for the respective quantum logic operations.

At step 508, the spent quantum objects are removed from the interaction locations. For example, the controller 30 controls operation of one or more components of the quantum computer (e.g., potential drivers) to cause the spent quantum objects to be removed from the respective interaction locations. In an example embodiment, the respective data qubits involved in remote quantum logic operations are measured and/or read as part of performing a respective remote quantum logic operation and the quantum objects that had embodied the respective data qubits are deemed to be spent quantum objects. In an example embodiment, the respective e-bits involved in remote quantum logic operations are measured and/or read as part of performing a respective remote quantum logic operation and the quantum objects that had embodied the respective e-bits are deemed to be spent quantum objects. The spent quantum operations may be transported back to one or more respective initialization and/or entanglement locations, in an example embodiment. In an example embodiment, the spent quantum objects are ejected from the confinement apparatus 50.

At step 510, one or more new entangled sets of e-bits are generated. For example, the controller 30 controls one or more components of the quantum computer 110 (e.g., potential drivers, manipulations sources, and/or the like) to cause one or more sets of e-bits to be entangled at respective entanglement locations. For example, the one or more single data qubit gates and/or two or more data qubit gates of an entanglement circuit portion 290 are performed on respective sets of two or more e-bits to generate respective entangled sets of e-bits.

At step 512, the controller 30 determines a respective route for each e-bit of the new entangled sets of e-bits that were generated at step 506. For example, for each respective e-bit of the respective entangled sets of e-bits that were generated at step 506, the controller 30 determines a respective route or path from the entanglement location where the respective entangled set of e-bits was generated to a respective interaction location where the respective e-bit will be used to perform a remote quantum logic operation at time step i + j of the quantum circuit, where j is a positive integer. The controller 30 may determine the route during circuit compilation and simply load the new route from memory and/or reference the route stored in memory to determine the next commands to be sent to the quantum device to perform the transport steps 502. Alternatively, the controller 30 may determine the route on the fly during device operation.

For example, the controller 30 may execute a routing algorithm to determine a lowest cost route from the respective entanglement location to the respective interaction location. In various embodiments, the cost of a route may take into account various factors such as total distance, number of junction traversals, number other quantum objects encountered along the route (e.g., the number of times a quantum object would need to be transported past another quantum object located on a same one-dimensional trapping region), and/or the like. For example, a path-finding algorithm such as Dijkstra’s algorithm (or another path finding algorithm) may be used to determine respective routes for each e-bit of the respective entangled set of e-bits.

In various embodiments, the controller 30 divides the respective route into j steps. For example, the respective e-bit is transported from the respective entanglement location to the respective interaction location such that the respective e-bit is disposed at the respective interaction location at time step i + j. For example, the respective e-bit is transported one step at time step i + 1, another step at time step i + 2, and so on through time step i + j where the respective e-bit reaches the respective interaction location. For example, the controller 30 may determine the transportation operations to be performed on the respective e-bit for each time step of the quantum circuit from time step i through time step i + j.

In various embodiments, one or more of steps 502, 504, 506, 508, 510, 512 are performed simultaneously and/or at least partially overlapping in time.

In various embodiments, a quantum circuit may include conditional branches. For example, at a given time step, the controller 30 may determine whether to continue performing the quantum circuit using a first quantum circuit branch or a second quantum circuit branch. When the branching of the quantum circuit affects only single qubit gates, the branching of the quantum circuit does not affect the pairing of e-bits with data qubits. Thus, when the branching of the quantum circuit affects only single qubit gates, the pipelined distribution of e-bits is not affected. In a scenario where the branching of the quantum circuit corresponds to performing a remote quantum logic operation on data qubits A and B under a first set of conditions (e.g., when the first set of conditions are satisfied) and performing a remote quantum logic operation on data qubits C and D otherwise (e.g., when the first set of conditions are not satisfied), respective entangled sets of e-bits may be generated and/or formed and routed for both the remote quantum logic operation to be performed on data qubits A and B and the remote quantum logic operation to be performed on data qubits C and D. The appropriate entangled set of e-bits may be used once it is determined whether or not the first set of conditions are satisfied and the un-used entangled set of e-bits may be used later in the quantum circuit or may be deemed spent quantum objects and ejected or transported back to an entanglement location. In a general branching scenario, the entangled sets of e-bits that are being routed through the confinement apparatus may be returned to respective entanglement locations and new entangled sets of e-bits may be generated based on the branching of the quantum circuit.

### Example Multi-domain Confinement Apparatus

FIG. 6 provides a cross-sectional view of an example multi-domain confinement apparatus 600 that may be used to enable pipelined performance of remote quantum logic operations. For example, in an example embodiment the confinement apparatus 50 of the quantum computer 110 is a multi-domain confinement apparatus 600. The multi-domain confinement apparatus 600 is a multi-layer confinement apparatus where each domain comprises and/or is embodied as one or more layers of the multi-layer confinement apparatus.

In various embodiments, a multi-domain confinement apparatus 600 comprises an entanglement domain 632 comprising and/or embodied as entanglement layer 622, routing domain 634 comprising and/or embodied as routing layers 624 (e.g., 624A, 624B, 624(N-1), 624N), and an interaction domain 636 comprising and/or embodied as interaction layer 626. Each layer corresponds to and/or comprises a substrate 604 (e.g., 604A, 604B, 604C, 604D, 604E, 604N, 604(N+1)) having one or more confinement devices 610 (e.g., 610A, 610B, 610C, 610D, 610E, 610N, 610(N+1)) each comprising a respective plurality of electrodes formed thereon, and a confinement space 630 (e.g., 630A, 630B, 630C, 630N, 630(N+1)) having one or more confinement regions defined therein by the application of voltage signals to the pluralities of electrodes. In various embodiments, the multi-domain confinement apparatus 600 further includes a loading/initializing domain 620. In various embodiments, the multi-domain confinement apparatus 600 further includes a cloud chip 606, which may include one or more photonic integrated circuits (PICs), photon detectors, manipulation sources, and/or the like.

In an example embodiment, a quantum object source 602 is configured to provide a stream or flux of quantum objects toward a first substrate 604A. An example quantum object source 602 is described by U.S. Patent Application No. 17/651,840, filed Feb. 21, 2022, the content of which is incorporated herein by reference in its entirety. In various embodiments, various other quantum object sources 602 may be used, as appropriate for the quantum objects and the multi-domain confinement apparatus 600.

The first substrate 604A includes through holes 605. Quantum objects provide by the quantum object source 602 travel through the through holes 605 into the confinement space 630A of the loading/initialization domain 620. In an example embodiment, the quantum objects provided by the quantum object source are ions. In an example embodiment, the quantum objects provided by the quantum object are neutral atoms and a manipulation source 64 is configured to provide an ionizing beam that is incident on one or more ionizing locations of the loading/initialization domain 620. When the ionizing beam is incident on a neutral atom at an ionizing location, the neutral atom is ionized to form an ion. The plurality of electrodes of the confinement device 610A of the loading/initialization domain 620 is configured to confine the ions in confinement regions defined by the application of voltage signals (e.g., generated and/or provided by the potential drivers) to respective electrodes of the plurality of electrodes of the confinement device 610A of the loading/initialization domain 620.

In an example embodiment, the quantum objects are initialized into a qubit state (e.g., the first qubit state |0> or the second qubit state |1>) while the quantum object is disposed within the confinement space 630A of the loading/initialization domain 620. For example, once the quantum object is confined within a confinement region defined by the plurality of electrodes of the confinement device 610A of the loading/initialization domain 620, the quantum object may be transported to an initialization location. While the quantum object is disposed at the initialization location, one or more manipulation signals may be incident on the quantum object such that the quantum state of the quantum object is manipulated to cause the quantum object to be in a known qubit state. In an example embodiment, the initialization of the quantum object is performed while the quantum object is disposed in the confinement space 630B of the entanglement layer 622.

The confinement device 610A of the loading/initialization domain 620 transports the quantum object to an inter-layer routing location configured to enable the transportation of the quantum object from the confinement space 630A of the loading/initialization domain 620 to the confinement space 630B of the entanglement layer 622. For example, at the inter-layer routing location, a through hole through the substrate 604B enables the quantum object to pass through the substrate 604B. The electrodes of the plurality of electrodes of the confinement device 610A at and/or proximate the inter-layer routing location are configured to, when an appropriate voltage signal is applied thereto, are configured to generate an electric potential that causes the quantum object to travel through the through hole in the substrate 604B and into the confinement space 630B of the entanglement layer 622.

The plurality of electrodes of the confinement device 610B of the entanglement layer 622 is configured to confine the quantum object as the quantum object enters the confinement space 630B at the inter-layer routing location. The plurality of electrodes of the confinement device 610B of the entanglement layer 622 is further configured to transport the quantum object to a respective entanglement location 652 defined at least in part by the confinement device 610B of the entanglement layer 622. For example, the confinement device 610B of the entanglement layer 622 may define a plurality of entanglement locations.

When the quantum object is located at an entanglement location 652 along with at least one other quantum object (e.g., such that at least two quantum objects are disposed at the entanglement location 652), the quantum object is entangled with the other quantum object(s) disposed at the entanglement location 652 to generate and/or form an entangled set of e-bits.

In various embodiments, the entangled set of e-bits are assigned to a particular quantum logic operation to be performed at a particular time step of a quantum circuit being performed by the quantum computer 110. For example, an entangled set of e-bits that is generated and/or formed at time step i of the quantum circuit may be assigned to a quantum logic operation to be performed at time step i + j of the quantum circuit that is to be performed as a remote quantum logic operation, where i and j are both positive integers. The quantum logic operation includes interacting a first data qubit and a second data qubit in a particular manner (e.g., a CNOT gate, a ZZ gate, a gate drawn from the special unitary group of degree 4 operations, and/or the like). At time step i + j, the first data qubit is to be located at a first interaction location 654A and the second data qubit is to be located at a second interaction location 654B that is physically separated from and/or distinct from the first interaction location 654A (for example, the second interaction location 654B is separated from the first interaction location 654A by 10 μm or more and possibly up to several millimeters). Thus, a first e-bit of the entangled set of e-bits is routed through the routing layers 624 such that the first e-bit is disposed at the first interaction location 654A at time step i + j and the second e-bit of the entangled set of e-bits is routed through the routing layers 624 such that the second e-bit is disposed at the second interaction location 654B at time step i + j.

For example, the confinement device 610B of the entanglement layer 622 is configured to transport each respective e-bit of the entangled set of e-bits from the respective entanglement location 652 to a respective inter-layer routing location configured to enable the transportation of the e-bit from the confinement space 630B of the entanglement layer 622 to the confinement space 630C of the first routing layer 624A. For example, at the inter-layer routing location, a through hole through the substrate 604C enables the respective e-bit (e.g., the quantum object embodying the respective e-bit) to pass through the substrate 604C. The electrodes of the plurality of electrodes of the confinement device 610B at and/or proximate the inter-layer routing location are configured to, when an appropriate voltage signal is applied thereto, generate an electric potential that causes the e-bit to travel through the through hole in the substrate 604C and into the confinement space 630C of the first routing layer 624A.

The plurality of electrodes of the confinement device 610C of the first routing layer 624A is configured to confine the e-bit as the e-bit enters the confinement space 630C at the inter-layer routing location. The plurality of electrodes of the confinement device 610C of the first routing layer 624A is further configured to transport the e-bit along a portion of a path or route to a respective interaction location 654 defined at least in part by the confinement device 610(N+1) of the interaction layer 626.

The respective e-bit may be transported through the plurality of routing layers 624A-N in accordance with the route and/or path determined and/or assigned to the e-bit via a plurality of inter-layer routing locations 615 until the respective e-bit reaches the interaction layer 626 (e.g., via an inter-layer routing location including a through hole through the substrate 604(N+1)). In an example embodiment, the route or path determined and/or assigned to the e-bit causes the respective e-bit to reach the interaction layer 626 near the respective interaction location 654. For example, the route or path determined and/or assigned to the e-bit is configured such that when the respective e-bit reaches the interaction layer 626, minimal transportation is required to cause the respective e-bit to be disposed at the respective interaction location 654.

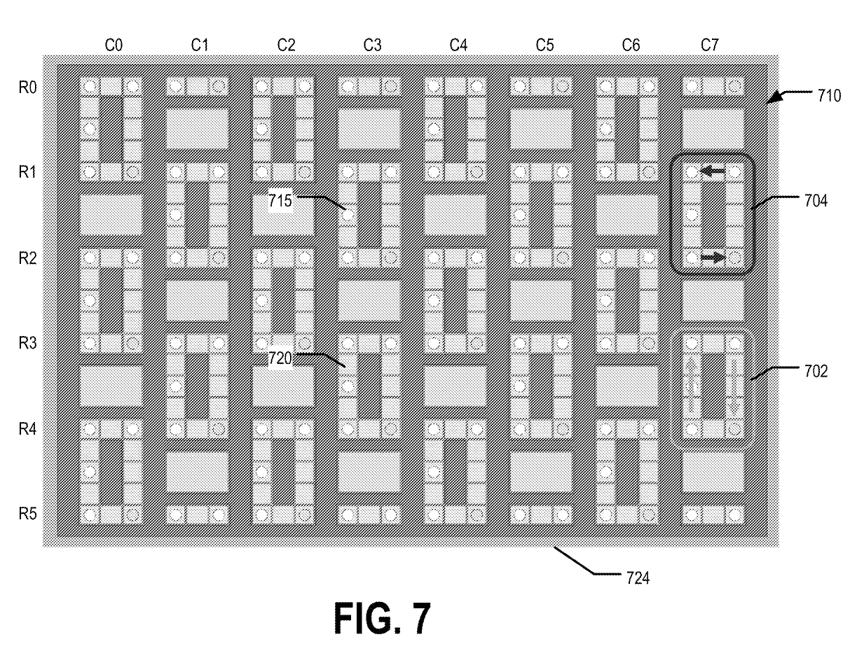

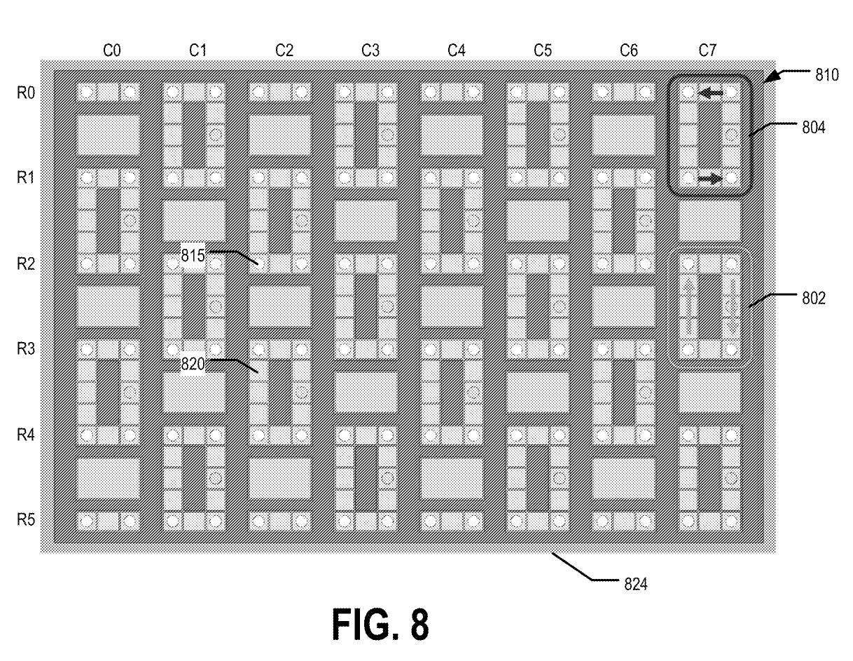

In an example embodiment, each of the interaction layer 626 and each of the routing layers 624 include a respective plurality of electrodes configured to define and/or generate fully connected two-dimensional array of one-dimensional trapping regions. In an example embodiment, at least one of the interaction layers 626 and/or the routing layers 624 includes an array or two-dimensional collection of one-dimensional trapping regions that is not fully connected. In an example embodiment, one or more of the routing layers 624 are configured for performance of specific routing operations. For example, FIG. 7 illustrates an example routing layer 724 configured to perform a first example set of intra-column row swap-or-not routing operations and FIG. 8 illustrates an example routing layer 824 configured to perform a second example set of intra-column row swap-or-not routing operations. As should be understood, routing layers configured to perform even and/or odd intra-row swap-or-not routing operations may also be used in various embodiments. Various other routing operations may be defined and routing layers specifically designed for performance of such routing operations may be incorporated into various embodiments of multi-layer confinement apparatuses.

For example, FIG. 7 illustrates an example routing layer 724 configured to perform even intra-column swap-or-not routing operations. The circles show the through holes 715 of the inter-layer routing locations through the substrate on which the electrodes 720 of the plurality of electrodes of the confinement device 710 are formed and/or disposed. The example routing layer 724 includes eight columns (e.g., C0, C1, C2, C3, C4, C5, C6, C7) and six rows (e.g., R0, R1, R2, R3, R4, R5). The routing layer 724 is configured to enable an e-bit in one of column C0, C2, C4, or C6 to be transported from row R0 to R1 (or vice versa), from R2 to R3 (or vice versa), or from R4 to R5 (or vice versa) while remaining in the same column. The routing layer 724 is also configured to enable an e-bit in one of column C1, C3, C5, or C7 to be transported from row R1 to row R2 (and vice versa) or from row R3 to row R4 (or vice versa) while remaining in the same column. Box 702 shows an instance where an e-bit is transported in column C7 from row R3 to row R4 (or vice versa). Box 704 shows an instance where an e-bit is disposed in column C7 and row R1 and stays in column C7 and row R1 and an e-bit that is disposed in column C7 and row R2 and stays in column C7 and row R2. Thus, the routing layer 724 is configured to enable even intra-column swapping of an e-bit or to enable an e-bit to maintain its column and row as the e-bit is transported through the routing layer 724.

In another example, FIG. 8 illustrates an example routing layer 824 configured to perform odd intra-column swap-or-not routing operations. The circles show the through holes 815 of the inter-layer routing locations through the substrate on which the electrodes 820 of the plurality of electrodes of the confinement device 810 are formed and/or disposed. The example routing layer 824 includes eight columns (e.g., C0, C1, C2, C3, C4, C5, C6, C7) and six rows (e.g., R0, R1, R2, R3, R4, R5). The routing layer 824 is configured to enable an e-bit in one of column C1, C3, C5, or C7 to be transported from row R0 to R1 (or vice versa), from R2 to R3 (or vice versa), or from R4 to R5 (or vice versa) while remaining in the same column. The routing layer 824 is also configured to enable an e-bit in one of column C0, C2, C4, or C6 to be transported from row R1 to row R2 (or vice versa) or from row R3 to row R4 (or vice versa) while remaining in the same column. Box 802 shows an instance where an e-bit is transported in column C7 from row R2 to row R3 (and vice versa). Box 804 shows an instance where an e-bit is disposed in column C7 and row R0 and stays in column C7 and row R0 and an e-bit that is disposed in column C7 and row R1 and stays in column C7 and row R1. Thus, the routing layer 824 is configured to enable odd intra-column swapping of an e-bit or to enable an e-bit to maintain its column and row as the e-bit is transported through the routing layer 824.

As should be understood, routing layers similar to routing layers 724, 824 may be designed and/or configured to enable various sets of intra-row column swap-or-not routing operations. In various embodiments, a multi-layer confinement apparatus comprises a plurality of routing layers where adjacent routing layers are configured to perform different sets of routing functions. For example, in an example embodiment, a routing layer 624m, where m is an index that indexes the routing layers, is configured to perform a first set of routing functions and routing layer 624(m-1) (and/or routing layer 624(m+1) is configured to perform a second set of routing functions that is different from the first set of routing functions. The first set of routing functions are different form the second set of routing functions in that the second set of routing functions includes at least one routing function that is not in the first set of routing functions and the first set of routing functions includes at least one routing function that is not in the second set of routing functions. For example, routing layer 624m may be routing layer 724 and routing layer 624(m-1) may be routing layer 824. Additionally, routing layer 624(m+1) may be a routing layer configured for performance of intra-row column swap-or-not routing operations.

In various embodiments, the routing layers may include one or more return path portions. For example, the multi-domain confinement apparatus may include one or more return paths for transporting spent quantum objects back to the entanglement layer 622, for example, to be re-initialized and used as an e-bit in another entangled set of e-bits.

In various embodiments, the routing layers 624 may include one or more general routing layers that can perform any step of a route. For example, a general routing layer is configured to perform a plurality of routing functions and/or enable the transport of an e-bit from a first arbitrary position defined by the general routing to layer to a second arbitrary position defined by the general routing layer. In various embodiments, a single routing layer may perform one or more routing steps in a row and/or in succession/series before the e-bits are transported to the next adjacent routing layer. In this way, there are many different routing layer configurations, some with more routing layers, which in some embodiments leads to higher throughput of gating operations, and some with fewer routing layers, which in some embodiments leads to lower throughput of gating operations.

In various embodiments where the quantum computer 110 includes a multi-domain confinement apparatus, the controller 30 is configured to cause the quantum computer 110 to perform a quantum circuit by filling the pipeline of e-bits of respective entangled sets of e-bits such that when the quantum logic operations of time step 0 of the quantum circuit are performed, the e-bits for use in performing the quantum logic operations of time steps 1 through j + 1 are at appropriate points in their routes to arriving at respective interaction locations at the appropriate time step. Thus, at each time step, a minimal amount of e-bit transportation is required to prepare for performing the next group of quantum logic operations. In an example embodiment, the quantum objects embodying the data qubits may stay at or near a respective interaction location such that transportation of the data qubits is minimized.

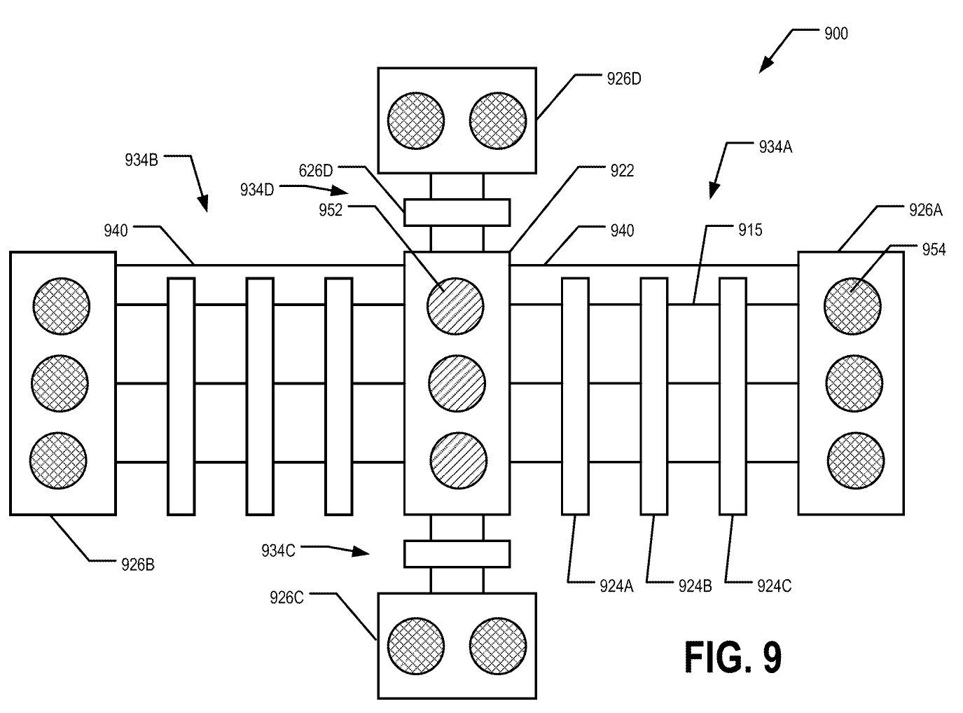

The multi-domain confinement apparatus 600 is a 3D multi-domain confinement apparatus 600 where each domain comprises and/or is embodied as one or more 2D layers (or portion thereof) of the confinement apparatus 600. In various other example embodiments, the multi-domain confinement apparatus is a 2D multi-domain confinement apparatus and the various domains comprise and/or are embodied as one or more 2D and/or 1D layers of the confinement apparatus (see, for example, FIGS. 5A, 5B, and 9).

In an example embodiment, the multi-domain confinement apparatus includes an entanglement domain that is disposed in the middle of the multi-domain confinement apparatus. The multi-domain confinement apparatus also includes a plurality of routing domains, each comprising a respective one or more routing layers, and a plurality of interaction domains. An e-bit may be transported from the entanglement domain into a respective one of the plurality of routing domains. The e-bit is then transported through the respective routing layer(s) of the respective routing domain to a respective interaction domain. Each of the plurality of routing domains is accessible from the entanglement domain, and each of the plurality of routing domains provides access to a respective interaction domain.

For example, FIG. 9 illustrates an example multi-domain confinement apparatus 900 that includes an entanglement domain 922, a plurality of routing domains 934 (e.g., 934A, 934B, 934C, 934D), and a plurality of interaction domains 926 (e.g., 926A, 926B, 926C, 926D). The routing domains 934 comprise respective routing layers 924 (e.g., 924A, 924B, 924C, 924D). Each of the entanglement domain 922, routing layers 924, and interaction domains 926 is a respective 1D or 2D region of the multi-domain confinement apparatus 900. The entanglement domain 922 defines and/or includes a plurality of entanglement locations 952. Each routing domain 934 is accessible from the entanglement domain 922 and provides access to a respective interaction domain 926 of the plurality of interaction domains. A respective interaction domain 926 is only accessible via the corresponding set of routing domains 934. In the illustrated embodiment, an e-bit must pass through each routing layer 924 of a respective routing domain 934 to reach the respective interaction domain 926. Each interaction domain 926 defines one or more interaction locations 954. The multi-domain confinement apparatus 900 further includes one or more quantum object return paths 940 that enable spent quantum objects to be transported from a respective interaction domain 926 to the entanglement domain 922.

### Example Fabrication of a 3D Multi-Domain Confinement Apparatus

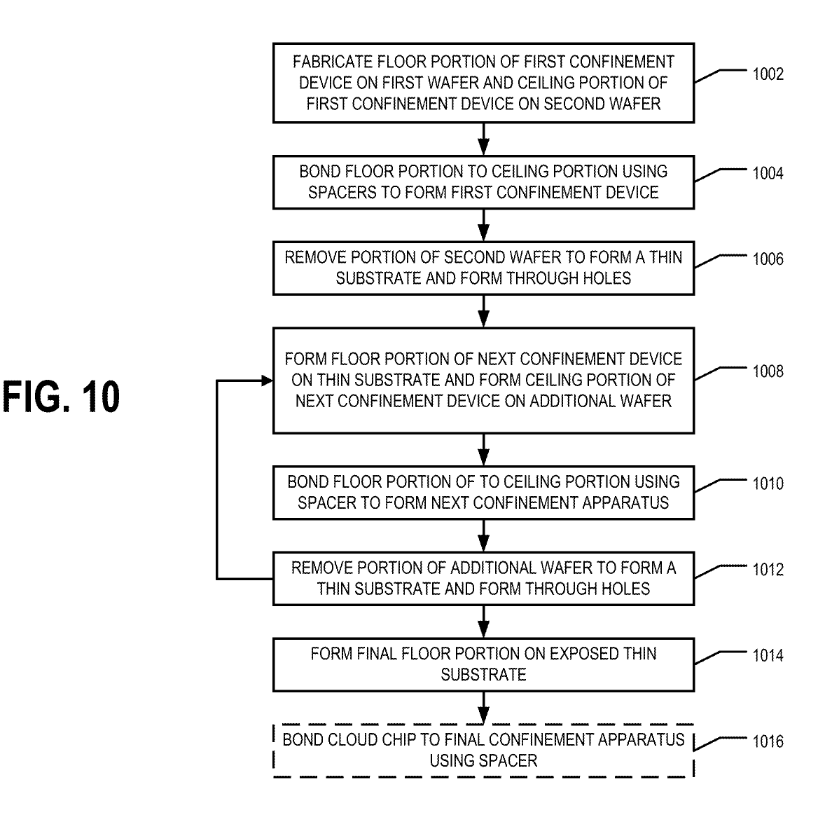

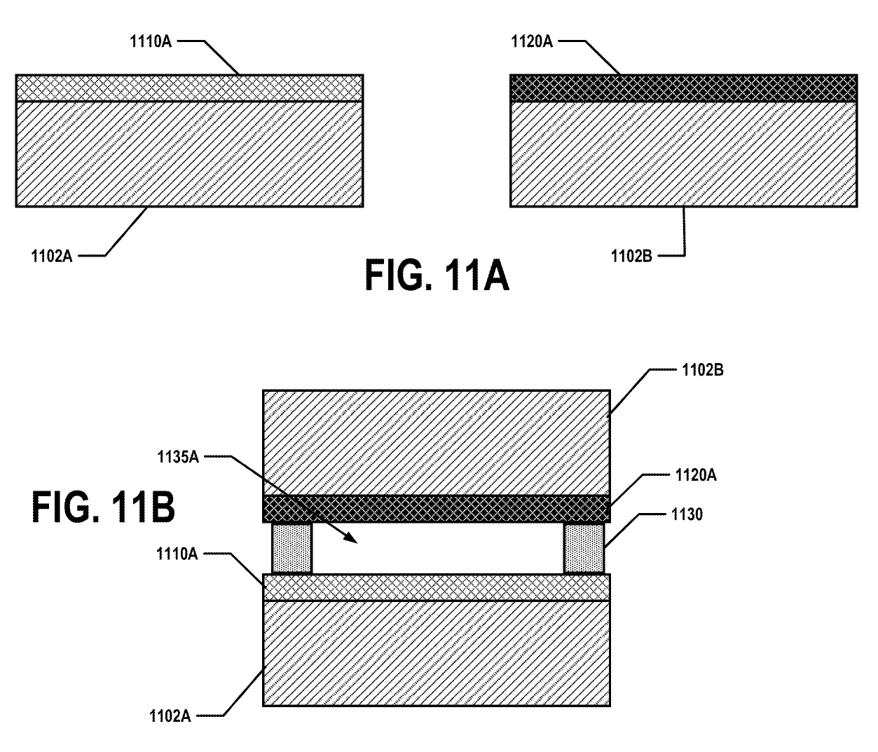

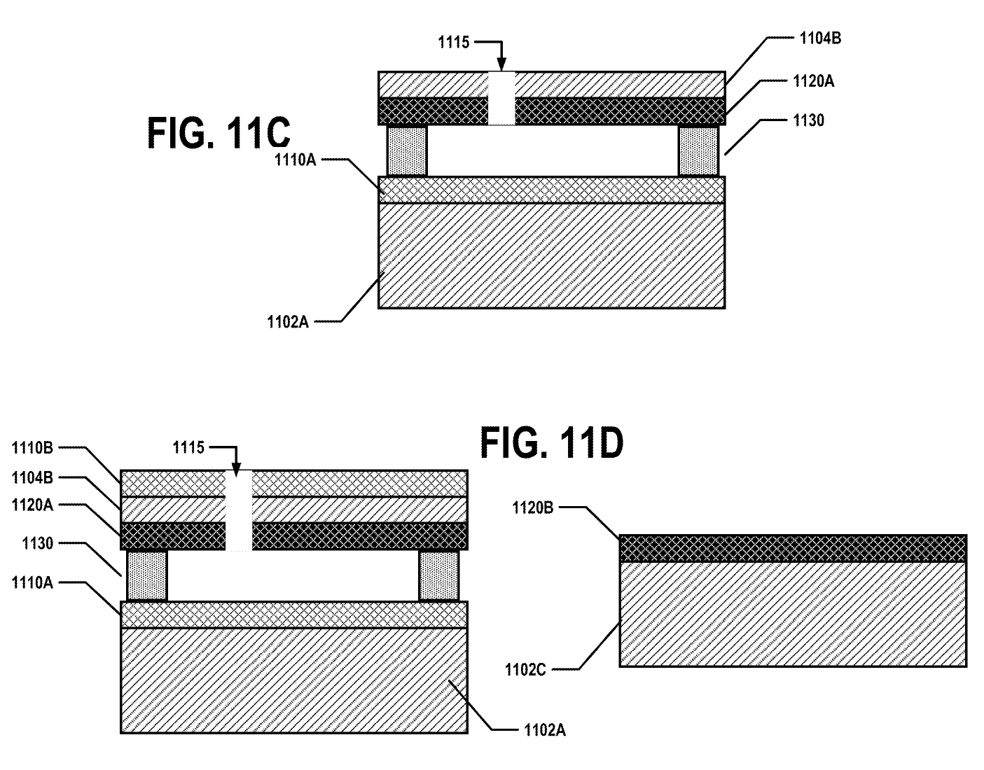

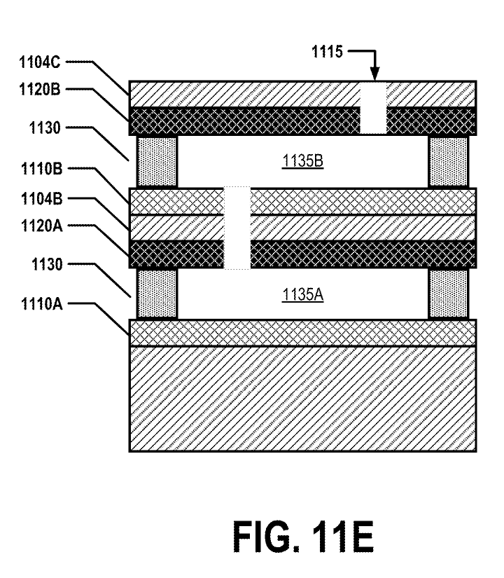

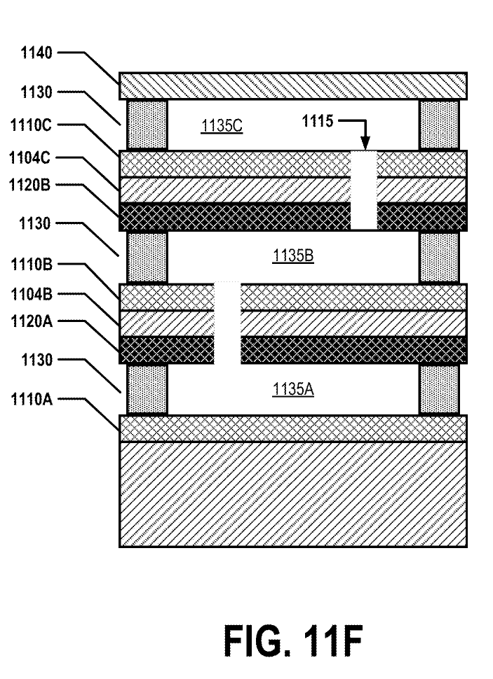

FIGS. 10 and 11A-11F disclose example embodiments for fabricating a multi-domain confinement apparatus where each domain comprises and/or is embodied by one or more 2D layers (or portion thereof) in a 3D confinement apparatus (e.g., such as the multi-domain confinement apparatus 600 illustrated in FIG. 6).

Starting at step 1002, and as shown in FIG. 11, the floor portion 1110A of a first confinement device is fabricated on a first wafer 1102A and the ceiling portion 1120A of the first confinement device is fabricated on a second wafer 1102B. In various embodiments, the floor portion 1110 (e.g., 1110A, 1110B, 1110C) of a confinement device includes a plurality of electrodes (e.g., RF electrodes, control electrodes, and/or the like) configured for generating confining potentials configured to confine quantum objects. In various embodiments, the ceiling portion 1120 (e.g., 1120A, 1120B) comprises a plurality of electrodes that complement those on the floor portion and together with the electrodes of the floor portion are configured to enable transportation of quantum objects between confinement devices. As should be understood, the particular electrode layout of the floor portion 1110 and the ceiling portion 1120 of a confinement device is determined and/or designed based on the intended application.

Continuing with FIG. 10, at step 1004, and as illustrated in FIG. 11B, the floor portion 1110A of the first confinement device 1135A is bonded to the ceiling portion of the first confinement device 1135A using spacers 1130. In various embodiments, the spacers 1130 are bump or ball bonds that are used to bond the floor portion 1110A to the ceiling portion 1120A. In various embodiments, the spacers 1130 are patterned dielectric and/or metallic structures deposited, grown, thermally formed, and/or layer transferred from another wafer. In various embodiments, the spacers 1130 may be a semiconductor (e.g., Si), conductor (metal), or insulating dielectric substrate, metallic solder bumps, epoxy, or ball bonds that are used to bond the floor portion 1110A to the ceiling portion 1120A.

In various embodiments, the spacers 1130 are configured to cause the floor portion 1110A to be separated from the corresponding ceiling portion 1120A by a distance of 5-300 μm. For example, in an example embodiment, the spacers 1130 are configured to cause the floor portion 1110A to be separated from the corresponding ceiling portion 1120A by a distance of 5-60 μm.

At step 1006, and as illustrated in FIG. 11C, at least a portion of the second wafer 1102B is removed so that a thin substrate 1104B remains. For example, the second wafer 1102B may be ground, etched, chemically and mechanically polished and/or the like down until a thin substrate 1104B remains. For example, the ceiling portion 1120A is formed on a first surface of the second wafer 1102B and a surface of the second wafer 1102B that is opposite the first surface is etched away to form a thin substrate 1104B. In various embodiments, the thin substrate 1104B is 5-500 μm thick. In various embodiments, one or more through holes 1115 are etched through the thin substrate 1104B (and possibly through the ceiling portion 1120A if the openings for the through hole(s) are not already present). The through holes 1115 are configured to enable quantum objects (e.g., e-bits, spent quantum objects, and/or the like) to pass therethrough. For example, the through holes 1115 are configured to enable the quantum objects to be transported between adjacent confinement devices 1135 (e.g., 1135A, 1135B, 1135C) and/or layers of the confinement apparatus.

At step 1008, and as shown in FIG. 11D, the floor portion 1110B of the next confinement device is formed on the exposed surface of the thin substrate 1104B and the ceiling portion 1120B of the next confinement device is formed on an additional wafer 1102C. For example, the ceiling portion 1120A of the first confinement device is disposed on a first surface of the thin substrate 1104B and floor portion 1110B of the next confinement device is formed on a second surface of the thin substrate 1104B that is opposite the first surface of the thin substrate.

At step 1010, the floor portion 1110B of the next confinement device 1135B is bonded to the ceiling portion 1120B of the next confinement device 1135B using spacers 1130. In various embodiments, the spacers 1130 are bump or ball bonds that are used to bond the floor portion 1110B to the ceiling portion 1120B. In various embodiments, the spacers 1130 are patterned dielectric and/or metallic structures deposited, grown, thermally formed, and/or layer transferred from another wafer. In various embodiments, the spacers 1130 may be a semiconductor (e.g., Si), conductor (metal), or insulating dielectric substrate, metallic solder bumps, epoxy, or ball bonds that are used to bond the floor portion 1110A to the ceiling portion 1120A.

In various embodiments, the spacers 1130 are configured to cause the floor portion 1110A to be separated from the corresponding ceiling portion 1120A by a distance of 5-300 μm. For example, in an example embodiment, the spacers 1130 are configured to cause the floor portion 1110A to be separated from the corresponding ceiling portion 1120A by a distance of 5-60 μm.

At step 1012, and as illustrated in FIG. 11E, at least a portion of the additional wafer 1102C is removed so that a thin substrate 1104C remains. For example, the additional wafer 1102C may be etched down until a thin substrate 1104C remains. In various embodiments, the thin substrate 1104C is 5-500 μm thick. In various embodiments, one or more through holes 1115 are etched through the thin substrate 1104C (and possibly through the ceiling portion 1120B if the openings for the through hole(s) are not already present). The through holes 1115 are configured to enable quantum objects (e.g., e-bits, spent quantum objects, and/or the like) pass therethrough. For example, the through holes 1115 are configured to enable the quantum objects to be transported between adjacent confinement devices 1135 (e.g., 1135A, 1135B, 1135C) and/or layers of the confinement apparatus.

Steps 1008-1012 may be repeated one or more times. For example, the number of times steps 1008-1012 are repeated depends on the number of layers of the multi-domain confinement apparatus. For example, for a confinement apparatus comprising N + 1 layers and/or confinement devices (e.g., each confinement device corresponding to a layer), the performance of steps 1002-1006 and the repeated performance of steps 1008-1012 (e.g., repeated N-1 times) cause the fabrication of the first N layers and/or confinement devices. The fabrication process then continues to step 1014 of FIG. 10. A total of three layers are shown in FIG. 11F, but various other embodiments may include more than three layers or two layers.

At step 1014, and as shown in FIG. 11F, the final floor portion 1110C (e.g., the floor portion of the final confinement device 1135C) is formed on the exposed thin substrate 1104C. In an example embodiment, the final confinement device 1135C does not include a ceiling portion. In an example embodiment, the final confinement device 1135C includes a ceiling portion formed on a cloud chip 1140.

At optional step 1016, a cloud chip 1140 is bonded onto the final floor portion 1110C using spacers 1130. In various embodiments, the spacers 1130 are bump or ball bonds that are used to bond the floor portion 1110B to the ceiling portion 1120B. In various embodiments, the spacers 1130 are patterned dielectric and/or metallic structures deposited, grown, thermally formed, and/or layer transferred from another wafer. In various embodiments, the spacers 1130 may be a semiconductor (e.g., Si), conductor (metal), or insulating dielectric substrate, metallic solder bumps, epoxy, or ball bonds that are used to bond the floor portion 1110A to the ceiling portion 1120A. In various embodiments, the cloud chip 1140 includes a ceiling portion of the final confinement device 1135C, a photonic integrated circuit (PIC) for providing light to quantum objects confined by the final confinement device 1135C and/or capturing light emitted by quantum objects confined by the final confinement device 1135C, detectors for capturing light emitted by quantum objects confined by the final confinement device 1135C, manipulation sources for generating manipulation signals applied to quantum objects confined by the final confinement device 1135C, and/or the like.

### Technical Advantages

QCCD-based quantum computers used confined quantum objects (e.g., ions and/or the like) as qubits of the quantum computer. The quantum objects may be transported to different locations within the confinement apparatus that confines the quantum objects to enable the pairing of arbitrary pairs of quantum objects for interaction. For example, arbitrary pairs of quantum objects may be generated such that quantum logic operations may be performed on the arbitrary pairs of quantum objects. However, the transportation operations used to transport the quantum objects within the confinement apparatus amount for a significant amount of time required by a QCCD-based quantum computer for performing quantum computations. As a result, the throughput or bandwidth of QCCD-based quantum computers can be limited by the latency caused by transportation of the quantum objects. Thus, technical problems exist regarding how to increase the throughput of quantum operations across arbitrary pairings of data qubits or bandwidth of QCCD-based quantum computers.

Various embodiments disclosed herein provide technical solutions to these technical problems. For example, various embodiments provide for and/or enable the performance of remote quantum logic operations such that all-to-all connectivity of the quantum objects can be achieved without requiring transportation of data qubits. Moreover, various embodiments provide and/or enable the pipelined distribution of entangled sets of e-bits (e.g., a set or pair of quantum objects that have been initialized and then entangled with one another) such that remote quantum logic operations may be performed with high throughput, thereby hiding transportation latency via pipelining. For example, various embodiments provide and/or enable QCCD-based quantum computers to perform quantum computations on a throughput limited time scale rather than a transportation latency limited time scale. Thus, various embodiments provide improvements to the technical fields of confinement apparatuses, quantum computers (in particular, QCCD-based quantum computers), and operation of quantum computers (in particular, operation of QCCD-based quantum computers).

For example, in various embodiments, an entangled set of e-bits is generated (e.g., at an entanglement location defined at least in part by a confinement apparatus). Respective e-bits of the set of e-bits are transported to respective interaction locations. Respective data qubits of a set of data qubits upon which the remote quantum logic operation is to be performed are located at and/or transported to the respective interaction locations. At each of the respective interaction locations, a respective data qubit is interacted with a respective e-bit and a measurement or reading of one of the data qubit or the e-bit at each respective interaction location is performed. Whichever of the respective e-bit or the respective data qubit is the measured or read is now considered a spent quantum object and removed from the interaction location (e.g., ejected from the confinement apparatus, returned to an entanglement location for reuse, and/or the like). Whichever of the respective e-bit or the respective data qubit was not measured or read, is now the data qubit at the interaction location. Thus, various embodiments provide methods, confinement apparatuses, controllers, quantum computers and/or systems, computer program products, and/or the like that use quantum teleportation to perform remote quantum logic operations.

In various embodiments, at each time step of the quantum circuit, one or more entangled sets of e-bits are generated and the respective e-bits of the existing entangled sets of e-bits are each moved one transportation step closer to the respective interaction location at which the respective e-bit will be used to perform a remote quantum logic operation. Each time step of the quantum circuit operation further includes performing one or more remote quantum logic operations. For example, the respective e-bit to be used to perform a remote quantum logic operation at time step i at a respective interaction location is, at time step i-1, transported to close to within one transportation step of the respective interaction location, in an example embodiment. Thus, during time step i, minimal transportation of the respective e-bit is required to bring the respective e-bit into proximity (e.g., in the same potential well) with the respective data qubit such that an interaction between the respective e-bit and the respective data qubit may be performed and/or caused to cause performance of the remote quantum logic operation. Moreover, this enables each time step of the quantum circuit to be performed with minimal transportation latency.

In various embodiments, after the performance of a remote quantum logic operation, a quantum object that played the role of an e-bit in the remote quantum logic operation takes over the role of the data qubit and the quantum object that played the role of the data qubit in the remote quantum logic operation (which was measured and/or read as part of the remote quantum logic operation) is deemed a spent quantum object (e.g., recycled as an e-bit and/or the like). As a result, the quantum object acting as the data qubit only acts as the data qubit for a limited amount of time, which reduces the possibility of memory errors, loss of data qubit coherence, and/or the like. Thus, various embodiments provide additional technical improvements to the technical field of QCCD-based quantum computing.

### Exemplary Controller

In various embodiments, a quantum computer 110 further comprises a controller 30 configured to control various elements and/or components of the quantum computer 110. In various embodiments, a controller 30 may be configured to cause a quantum computer 110 to perform various operations (e.g., computing operations such as gate operations, cooling operations, transport operations, qubit interaction operations, qubit measuring and/or reading operations, leakage suppression operations, and/or the like). For example, the controller 30 may be configured to control operation of a confinement apparatus, such as a multi-layer confinement apparatus, to perform a quantum circuit using remote quantum logic operations using a pipelined distribution of respective e-bits of entangled sets of e-bits. In various embodiments, the controller 30 may be configured to control operation of a cryogenic system and/or vacuum system controlling the temperature and pressure within the cryogenic and/or vacuum chamber 40, manipulation sources 64, beam path systems 66, confinement apparatus 50, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the confinement apparatus 50.

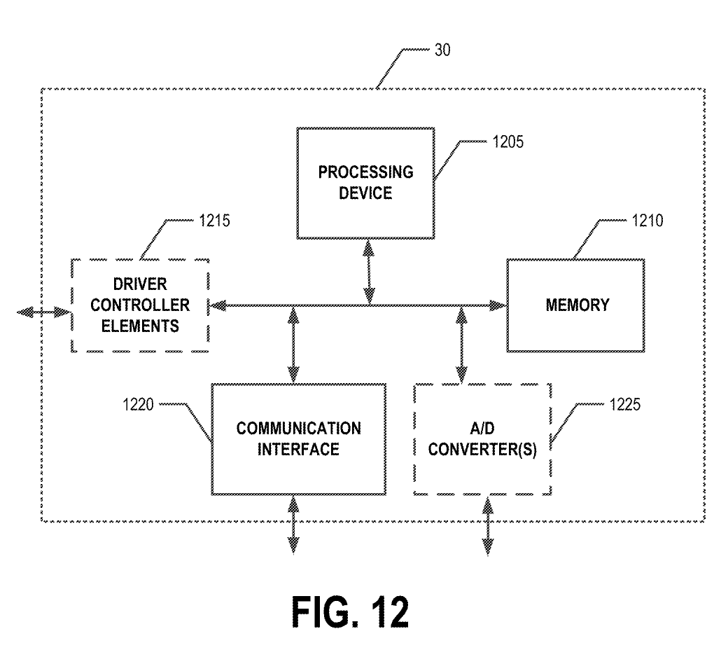

As shown in FIG. 12, in various embodiments, the controller 30 may comprise various controller elements including processing device 1205, memory 1210, driver controller elements 1215, a communication interface 1220, analog-digital converter elements 1025, and/or the like. For example, the processing device 1205 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing device 1205 of the controller 30 comprises a clock and/or is in communication with a clock.

For example, the memory 1210 may comprise non-transitory (classical and/or semiconductor-based) memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1210 may store qubit records corresponding the qubits of quantum computer (e.g., in a qubit record data store, qubit record database, qubit record table, quantum object database, and/or the like), a calibration table, an executable queue, computer program code (e.g., in a one or more computer languages, specialized controller language(s), and/or the like), and/or the like. In an example embodiment, execution of at least a portion of the computer program code stored in the memory 1210 (e.g., by a processing device 1205) causes the controller 30 to perform one or more steps, operations, processes, procedures and/or the like described herein.

In various embodiments, the driver controller elements 1215 may include one or more drivers and/or controller elements each configured to control one or more drivers. In various embodiments, the driver controller elements 1215 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 1205). In various embodiments, the driver controller elements 1215 may enable the controller 30 to operate manipulation sources 64, optical beam systems 66, the confinement apparatus 50, vacuum and/or cryogenic systems, and/or the like. In various embodiments, the drivers may be laser drivers; microwave drivers; vacuum component drivers; cryogenic and/or vacuum system component drivers; current drivers; potential drivers; voltage sources; and/or the like. For example, the drivers and/or driver controllers may be configured to cause the magnetic field generation device 70 (e.g., comprising circuitry coupled to a voltage source (e.g., a current driver or voltage driver), permanent magnet(s), and/or a combination thereof) to generate a magnetic field having a particular direction and magnitude at one or more positions of the confinement apparatus 50. In various embodiments, the controller 30 comprises means for communicating and/or receiving signals from one or more optical receiver components of the photon detection system 80, such as photodetectors, cameras, MEMs cameras, CCD cameras, photodiodes, photomultiplier tubes, and/or the like. For example, the controller 30 may comprise one or more analog-digital converter elements 1225 configured to receive signals from one or more optical receiver/sensor/detector components (e.g., of the photon detection system 80), calibration sensors, and/or the like.

In various embodiments, the controller 30 may comprise a communication interface 1220 for interfacing and/or communicating with a computing entity 10. For example, the controller 30 may comprise a communication interface 1220 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Exemplary Computing Entity

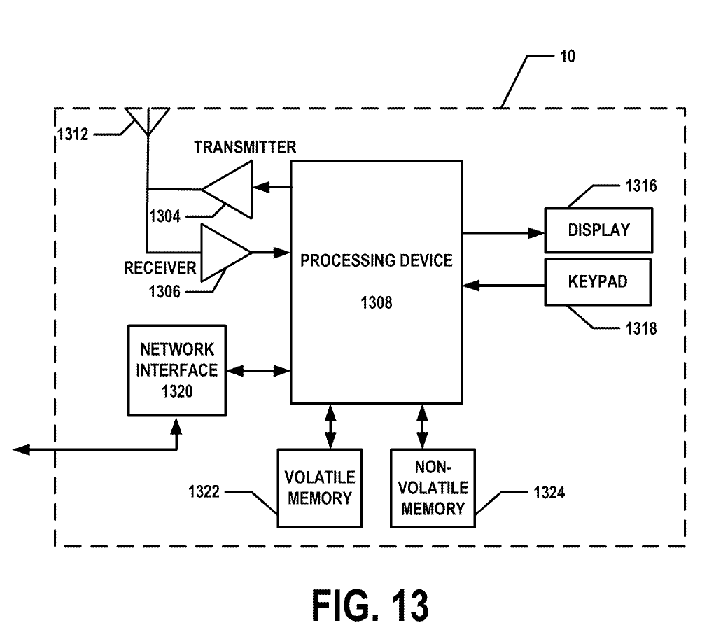

FIG. 13 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110. For example, a user may operate a computing entity 10 to generate and/or program a quantum algorithm and/or quantum circuit (e.g., that includes a four-tone phase insensitive MS gate) that may be provided such that the controller 30 may receive the quantum algorithm and/or quantum circuit and cause the quantum computer 110 to perform the quantum algorithm and/or quantum circuit.

As shown in FIG. 13, a computing entity 10 can include an antenna 1312, a transmitter 1304 (e.g., radio), a receiver 1306 (e.g., radio), and a processing device 1308 that provides signals to and receives signals from the transmitter 1304 and receiver 1306, respectively. The signals provided to and received from the transmitter 1304 and the receiver 1306, respectively, may include signaling information/data in accordance with an air interface standard of applicable wireless systems to communicate with various entities, such as a controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like. In various embodiments, the computing entity 10 includes a network interface 1320 configured to enable the computing entity 10 to communicate via one or more wired and/or wireless networks.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity comprises a processing device 1308. For example, the processing device 1308 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products.

The computing entity 10 may also comprise a user interface device comprising one or more user input/output interfaces (e.g., a display 1316 and/or speaker/speaker driver coupled to a processing device 1308 and a touch screen, keyboard, mouse, and/or microphone coupled to a processing device 1308). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1318 (hard or soft), a touch display, voice/speech or motion interfaces, scanners, readers, or other input device. In embodiments including a keypad 1318, the keypad 1318 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1322 and/or non-volatile storage or memory 1324, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for performing a remote two or more data qubit quantum logic operation, the method performed by a controller configured to control operation of one or more components of a quantum computer, the method comprising:
causing a set of e-bits to be entangled at an entangling location defined at least in part by a confinement apparatus, the set of e-bits comprising a first e-bit and a second e-bit, wherein the set of e-bits is entangled at a time step i of a quantum circuit being performed by the quantum computer, where i is positive integer;
causing (a) routing of the first e-bit to a first interaction location defined at least in part by the confinement apparatus and (b) routing the second e-bit to a second interaction location defined at least in part by the confinement apparatus, wherein a first data qubit is disposed at the first interaction location and a second data qubit is disposed at the second interaction location;
causing (a) interaction of the first e-bit and the first data qubit at the first interaction location at a time step i + j of the quantum circuit, where j is a positive integer, and (b) interaction of the second e-bit and the second data qubit at the second interaction location at the time step i + j of the quantum circuit; and
causing (a) a first reading operation to be performed on one of the first data qubit or the first e-bit and (b) a second reading operation to be performed on one of the second data qubit or the second e-bit.

2. The method of claim 1, further comprising tracking one or more correction gates in a classical memory of the controller.

3. The method of claim 1, wherein the routing of the first e-bit to the first interaction location and the routing of the second e-bit to the second interaction location occurs between time step i and time step i + j of the quantum circuit.

4. The method of claim 1, wherein the first e-bit is transported along a determined route from the entanglement location to the first interaction location in j route steps with each route step of the j route steps performed during a respective time step of the quantum circuit.

5. The method of claim 4, further comprising determining the determined route using a route-finding algorithm.

6. The method of claim 1, wherein the confinement apparatus is a multi-domain confinement apparatus, the entanglement location is disposed in an entanglement domain of the multi-domain confinement apparatus, the first and second interaction locations are disposed in one or more interaction domains of the multi-domain confinement apparatus, and the first e-bit is routed to the first interaction location through one or more routing layers of the multi-domain confinement apparatus.

7. The method of claim 6, wherein the multi-domain confinement apparatus is a multi-layer confinement apparatus comprising a plurality of layers with each domain of the multi-domain confinement apparatus comprising a respective one or more layers of the plurality of layers.

8. The method of claim 1, wherein the first e-bit is embodied by a first quantum object, the second e-bit is embodied by a second quantum object, the first data qubit is embodied by a third quantum object, and the second data qubit is embodied by a fourth quantum object;
wherein the first reading operation is performed on the third quantum object and the second reading operation is performed on the fourth quantum object; and
the method further comprising:
causing the third quantum object to be transported out of the first interaction location;
causing the first quantum object to assume the role of the first data qubit;
causing the fourth quantum object to be transported out of the second interaction location; and
causing the second quantum object to assume the role of the second data qubit.

9. The method of claim 8, further comprising causing the third quantum object and the fourth quantum object to be transported to respective entanglement locations of one or more entanglement locations of the confinement apparatus.

10. The method of claim 1, wherein the first e-bit is embodied by a first quantum object, the second e-bit is embodied by a second quantum object, the first data qubit is embodied by a third quantum object, and the second data qubit is embodied by a fourth quantum object;
wherein the first reading operation is performed on the first quantum object and the second reading operation is performed on the second quantum object; and
the method further comprising:
causing the first quantum object to be transported out of the first interaction location; and
causing the second quantum object to be transported out of the second interaction location.

11. The method of claim 10, further comprising causing the third quantum object and the fourth quantum object to be transported to respective entanglement locations of one or more entanglement locations of the confinement apparatus.

12. A quantum object confinement apparatus comprising:
an entanglement domain comprising an entanglement domain confinement device, the entanglement domain defining one or more entanglement locations, wherein the entanglement domain is configured for sets of e-bits to be entangled at respective entanglement locations;
a routing domain comprising one or more routing layers, each routing layer comprising a respective routing domain confinement device; and
an interaction domain comprising an interaction domain confinement device, wherein each of the respective routing domain confinement devices and the interaction domain confinement device are configured to enable quantum objects to pass there through at respective inter-layer routing locations, the interaction domain defining a plurality of interaction locations, wherein the interaction domain is configured for [data qubit]-[e-bit] pairs to be interacted at respective interaction locations.

13. The quantum object confinement apparatus of claim 12, wherein each of the one or more routing layers and the interaction domain comprise one or more inter-layer routing locations configured for routing quantum objects between adjacent layers.

14. The quantum object confinement apparatus of claim 13, each domain of the multi-domain quantum object confinement apparatus comprises one or more layers and each inter-layer routing location includes a respective through hole through a substrate of a respective layer of to enable the quantum objects to pass through the substrate at the inter-layer routing location.

15. The quantum object confinement apparatus of claim 12, wherein each routing layer of the one or more routing layers is configured to perform a respective set of routing operations.

16. The quantum object confinement apparatus of claim 15, wherein the one or more routing layers comprises a first routing layer and a second routing layer that is adjacent to the first routing layer, the first routing layer is configured for performing a first set of routing operations and the second routing layer is configured for performing a second set of routing operations, the first set of routing operations comprising a first routing operation that is not part of the second set of routing operations and the second set of routing operations comprising a second routing operation that is not part of the first set of routing operations.

17. The quantum object confinement apparatus of claim 12, wherein the interaction domain and the one or more routing layers define a return path configured for transporting quantum objects from the interaction domain to the entanglement domain.

18. The quantum object confinement apparatus of claim 12, wherein the entanglement domain is configured for sets of e-bits to be entangled at respective entanglement locations through the application of one or more quantum logic gates on respective sets of two or more quantum objects disposed at the respective entanglement locations.

19. The quantum object confinement apparatus of claim 12, wherein the quantum object confinement apparatus comprises a plurality of routing domains and a plurality of interaction domains, the plurality of routing domains comprises a first routing domain disposed on a first side of the entanglement domain and a second routing domain disposed on a second side of the entanglement domain, the first side the entanglement domain being opposite the second side of the entanglement domain, and the plurality of interaction domains comprising a first interaction domain disposed on the first side of the entanglement domain and a second interaction domain disposed on the second side of the entanglement domain.

20. A method for manufacturing a multi-layer confinement apparatus comprising a plurality of layers, the method comprising:
(a) fabricating a first floor portion of a first confinement device on a first wafer;
(b) fabricating a first ceiling portion of the first confinement device a second wafer;
(c) bonding the first floor portion of the first confinement device to the first ceiling portion of the first confinement device using one or more of first spacers;
(d) removing a portion of the second wafer that is opposite the first ceiling portion of the first confinement device to form a first thin substrate with the first ceiling portion formed on a first surface of the first thin substrate;
(e) fabricating a next floor portion of a next confinement device on a second surface of the first thin substrate, wherein the second side of the thin substrate is opposite the first side of the first thin substrate;
(f) fabricating a next ceiling portion of a next confinement device on an additional wafer;
(g) bonding the next floor portion of the next confinement device to the next ceiling portion of the next confinement device using a plurality of second spacers; and
(h) removing a portion of the additional wafer that is opposite the next ceiling portion of the next confinement device to form a next thin substrate.
